(19) United States
(12) Patent Application Publication
(10) Pub. No.: US 2026/0057742 A1
(43) Pub. Date: Feb. 26, 2026

(54) ELECTRONIC GAMING SYSTEMS HAVING BONUS EVENTS WITH PERSISTENT CREDIT VALUES

(71) Applicant: Aristocrat Technologies, Inc., Las Vegas, NV (US)

(72) Inventors: Christmas Uberuaga, Reno, NV (US); Scott Delekta, Las Vegas, NV (US); Allon Englman, Las Vegas, NV (US)

(21) Appl. No.: 18/884,846

(22) Filed: Sep. 13, 2024

Related U.S. Application Data
(60) Provisional application No. 63/686,299, filed on Aug. 23, 2024.

(51) Int. Cl. G07F 17/32

(52) U.S. Cl. CPC G07F 17/3267; G07F 17/3213

(57) ABSTRACT

An electronic gaming system includes a game controller including a processor(s) configured to display a bonus event. Displaying the bonus game event includes displaying a bonus game in a first instance of the bonus event, and controlling a plurality of bonus game reels of the bonus game to randomly display one bonus game symbol during a first bonus spin. The bonus game symbols can include a cumulative cash-on-reel (COR) symbol depicting a cumulative COR credit value corresponding to a credit value defined during a base reel game, prior to the bonus event. Displaying the bonus game also includes continuing to display the cumulative COR symbol in the bonus game reels during a subsequent bonus spin, redisplaying the bonus game at a second instance of the bonus event, and persisting to display the cumulative COR symbol as displayed during the first instance of the bonus event.

### RELATED APPLICATION(S)

The present application claims priority to U.S. Provisional Patent Application No. 63/686,299, filed Aug. 23, 2024, and entitled “ELECTRONIC GAMING SYSTEMS HAVING BONUS EVENTS WITH PERSISTENT CREDIT VALUES” which is hereby incorporated by reference in its entirety.

### TECHNICAL FIELD

The field of disclosure relates generally to electronic gaming., and more specifically, to electronic gaming systems, programs, and methods that include presenting bonus events within a bonus game of an electronic game that allows a credit value to be persistent throughout the entirety of the bonus event.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance (or single play) of a primary or base game. In some cases, a player may qualify for a special mode of the base game, a secondary game, or a bonus round of the base game by attaining a certain winning combination or triggering event in, or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Notably, some games may include an element of skill on the part of the player and are therefore not entirely random.

### BRIEF DESCRIPTION

In one aspect, an electronic gaming system includes at least one memory for storing instructions, and a game controller in communication with the at least one memory. The game controller includes at least one processor, when the instructions are executed by the at least one processor, the at least one processor is configured to: cause to be displayed on a display device a base reel game including a plurality of reels; determine that an outcome of the base reel game triggers a bonus event; and control the display device to display the bonus event including: cause to be displayed on the display device a bonus game in a first instance of the bonus event, the bonus game including a plurality of bonus game reels; control the plurality of bonus game reels of the bonus game to randomly display one bonus game symbol of a plurality of bonus game symbols in each row for each of the plurality of bonus game reels during a first bonus spin of a predetermined number of bonus spins, the bonus game symbols including a cumulative cash-on-reel (COR) symbol depicting a cumulative COR credit value corresponding to a cumulative credit value defined during the base reel game, prior to the triggering of the bonus event; in response to at least one row of at least one of the bonus game reels displaying the cumulative COR symbol of the bonus game symbols, continue to cause to be displayed the cumulative COR symbol in the at least one row of the at least one of the bonus game reels during a subsequent bonus spin of the predetermined number of bonus spins; and cause to redisplay the bonus game on the display device at a second instance of the bonus event, subsequent to the first instance, the redisplayed bonus game persisting to display the cumulative COR symbol as displayed during the first instance of the bonus event.

In another aspect, a method of electronic gaming implemented on an electronic gaming machine includes: causing to be displayed on a display device a base reel game including a plurality of reels; determining that an outcome of the base reel game triggers a bonus event; and controlling the display device to display the bonus event including: causing to be displayed on the display device a bonus game in a first instance of the bonus event, the bonus game including a plurality of bonus game reels; controlling the plurality of bonus game reels of the bonus game to randomly display one bonus game symbol of a plurality of bonus game symbols in each row for each of the plurality of bonus game reels during a first bonus spin of a predetermined number of bonus spins, the bonus game symbols including a cumulative cash-on-reel (COR) symbol depicting a cumulative COR credit value corresponding to a cumulative credit value defined during the base reel game, prior to the triggering of the bonus event; in response to at least one row of at least one of the bonus game reels displaying the cumulative COR symbol of the bonus game symbols, continuing to cause to be displayed the cumulative COR symbol in the at least one row of the at least one of the bonus game reels during a subsequent bonus spin of the predetermined number of bonus spins; and causing to redisplay the bonus game on the display device at a second instance of the bonus event, subsequent to the first instance, the redisplayed bonus game persisting to display the cumulative COR symbol as displayed during the first instance of the bonus event.

In an additional aspect, a non-transitory computer-readable storage medium with instructions stored thereon is provided. The instructions, in response to execution by at least one processor, cause the at least one processor to: cause to be displayed on a display device a base reel game including a plurality of reels; determine that an outcome of the base reel game triggers a bonus event; and control the display device to display the bonus event including: cause to be displayed on the display device a bonus game in a first instance of the bonus event, the bonus game including a plurality of bonus game reels; control the plurality of bonus game reels of the bonus game to randomly display one bonus game symbol of a plurality of bonus game symbols in each row for each of the plurality of bonus game reels during a first bonus spin of a predetermined number of bonus spins, the bonus game symbols including a cumulative cash-on-reel (COR) symbol depicting a cumulative COR credit value corresponding to a cumulative credit value defined during the base reel game, prior to the triggering of the bonus event; in response to at least one row of at least one of the bonus game reels displaying the cumulative COR symbol of the bonus game symbols, continue to cause to be displayed the cumulative COR symbol in the at least one row of the at least one of the bonus game reels during a subsequent bonus spin of the predetermined number of bonus spins; and cause to redisplay the bonus game on the display device at a second instance of the bonus event, subsequent to the first instance, the redisplayed bonus game persisting to display the cumulative COR symbol as displayed during the first instance of the bonus event.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 illustrates an example user interface or screenshot of a base reel game of an example electronic game in accordance with the present disclosure.

FIG. 5 illustrates an example user interface or screenshot of a triggered bonus event of the example electronic game in accordance with the present disclosure.

FIGS. 6A-6C each illustrate an example user interface or screenshot of the base reel game shown in FIG. 4 transitioning to the bonus event, in accordance with the present disclosure.

FIGS. 7A-7R each illustrate an example user interface or screenshot of a sequence of a triggered bonus event displayed on the example electronic game in accordance with the present disclosure.

FIG. 8 illustrates an example user interface or screenshot of the base reel game shown displayed on the example electronic game subsequent to the sequence of the triggered bonus event of FIGS. 7A-7R in accordance with the present disclosure.

FIGS. 9A-9E each illustrate an example user interface or screenshot of another implementation of the bonus event displayed on the example electronic game in accordance with the present disclosure.

FIGS. 10A-10C each illustrate an example user interface or screenshot of a sequence of a triggered bonus event including a second, distinct train for the triggered bonus event, in accordance with the present disclosure.

FIGS. 11A and 11B each illustrate an example user interface or screenshot of another implementation of the sequence of a triggered bonus event including a second, distinct train for the triggered bonus event in accordance with the present disclosure.

### DETAILED DESCRIPTION

In some known electronic gaming systems, awards and/or outcomes of a primary game may be presented to a player as awards and/or outcomes of a secondary game. For example, an electronic gaming device operating a Class II (e.g., bingo or keno) game may present an outcome of the Class II game as a reel game (e.g., a slot game) simulation. The outcome of the Class II game is determinative of an outcome of the simulated reel game. For example, an award value associated with the Class II game outcome may be presented in the simulated reel game outcome as a symbol combination and/or one or more special symbols that correspond to the same award value. In some known Class II games, the award value of the Class II game outcome may be partitioned or distributed across a base reel game outcome and one or more bonus game outcomes (e.g., outcomes of one or more free reel or wheel spins). For example, an award value associated with one or more winning bingo patterns may be presented as being awarded in a base reel game outcome and one or more bonus game outcomes. While some variations exist for presenting the Class II game outcome across the base reel game outcome and/or the one or more bonus game outcomes exist, the variability and flexibility in presenting these outcomes remain limited. A need exists to address these limitations, while also improving on machine performance, memory storage and the overall functioning of the networked system controlling the gaming devices.

Embodiments of the present disclosure provide systems, program products, and methods for displaying base reel game outcomes that may include a triggering of one or more bonus events, or alternatively in the instances of Class III gaming, displaying bonus events to the player. The bonus events described herein provide players with a fast-paced animation and the displaying of (potentially) multiple awards or credit values. Additionally, interactive bonus games allow the player to interact with the gaming machine to attempt to win additional awards and credit values during the game. Furthermore, each bonus event can include the ability for the player to play both a bonus game, as well as be presented bonus game features—each awarding additional credit values. Additionally with respect to the bonus game, credit values revealed on bonus game reels during the bonus event can be persistent and/or continuously displayed during subsequent instances of the bonus game. The bonus games and bonus features, along with the persistence of the credit values that potentially carry over through multiple bonus games during the bonus event, provide an improved electronic game by increasing the variability and flexibility in presenting winning outcomes of the bonus game (e.g., winning symbol combinations and/or special symbols) to the player while maintaining a level or reducing the level of memory and/or computational resources needed to provide these enhancements.

The persistency of a credit value through the bonus event may include, for example, continuously displaying a revealed cash-on-reel credit value within the bonus game. Specifically, during the bonus event, the bonus game can be presented to the player multiple times to increase the chances of winning and/or credit value awards associated with the bonus event. Where a credit value is displayed in the bonus game during a first bonus game being played during the bonus event, that credit value remains presented to the user during the remainder of the first bonus game, as well as during any subsequent bonus games (e.g., second bonus game, third bonus game, etc.) is presented to the player during the same bonus event. The persistent credit values that remain displayed during distinct instances of the bonus game potentially increase the credit values a player can win, while also increasing the variability of the game including the bonus event. This persistence in the credit values during the bonus event in turn can also improve control and assurance of RTP during the gameplay. Additionally, and to improve technical issues commonly experienced during game plays, persistence in the credit values over multiple displays of the bonus game during bonus events can also reduce the amount of memory required by the gameplay and/or reduce the computational resources needed to operate the game.

The example systems, program products, and methods of the present disclosure represent a technical improvement in the field of electronic gaming. Technical improvements represented by the present disclosure include: (i) presenting Class II and Class III game outcomes as one or more outcomes of a bonus game and/or bonus features during a single bonus event; (ii) provide credit values to persist and/or be continuously displayed and in turn awarded during a single bonus event; (iii) utilizing unique bonus game features to provide additional gameplay features/winning opportunities during the bonus event; (iv) increasing the flexibility and variability in presenting award values of a game outcome as one or more bonus game outcomes; (v) providing players the opportunity to actively participate during the bonus games; (vi) displaying immediate bonus game feedback to a player; (vii) displaying potential reward opportunities to the player for a bonus game in advance of triggering the bonus game; (viii) maintaining/reducing the amount of memory needed to carry out the improved variability of the gameplay as a result of persistent credit values; (ix) reducing the computational resources needed as a result of the persistent credit values that remain displayed throughout the bonus event and/or during distinct instances of the bonus game; and/or (x) improved control and assurance of RTP by enabling control of the credit awards through the persistent credit values in the bonus events. Additional and/or alternative technical improvements may exist.

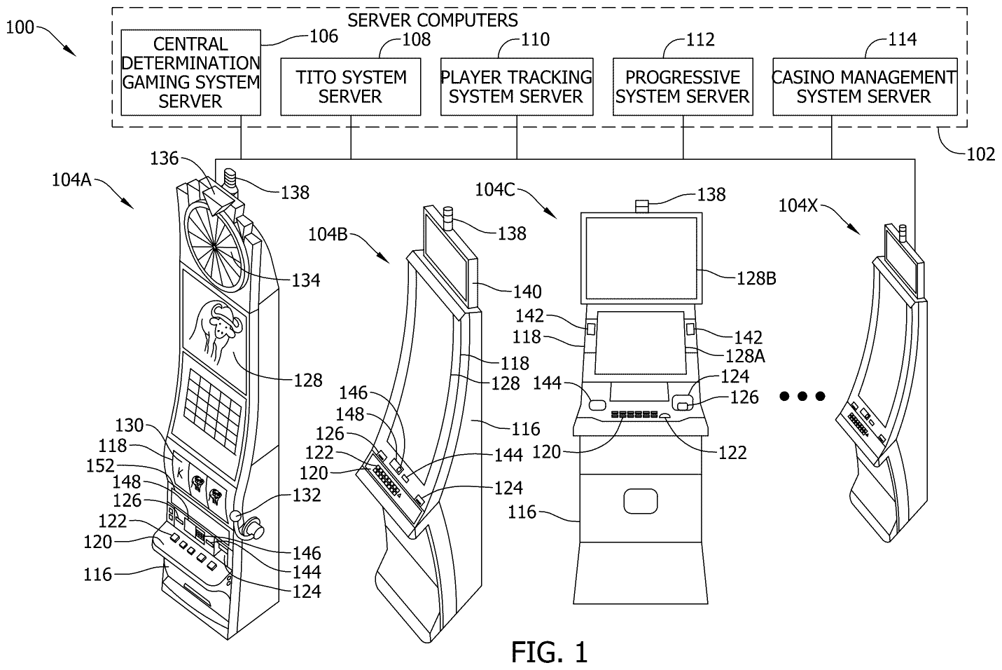

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers, private networks (e.g., local area networks and enterprise networks), and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi®) and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube, or other conventional electronically controlled video monitor.

In some implementations, the bill validator 124 may also function as a “ticket-in” reader that allows the player to use a casino issued credit ticket to load credits onto the gaming device 104A (e.g., in a cashless ticket (“TITO”) system). In such cashless implementations, the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player's smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

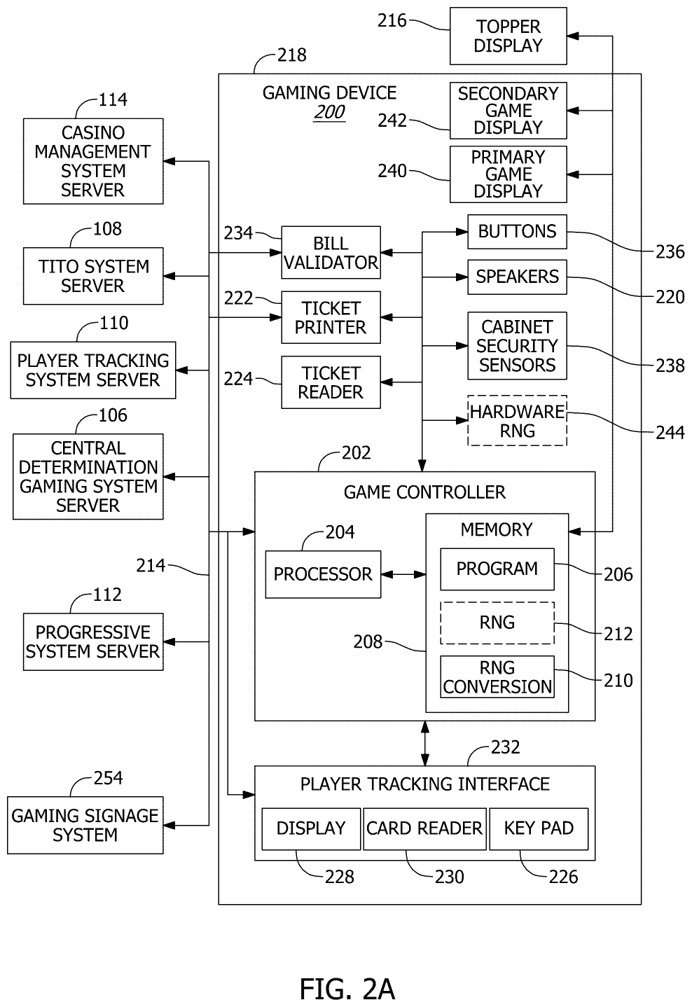

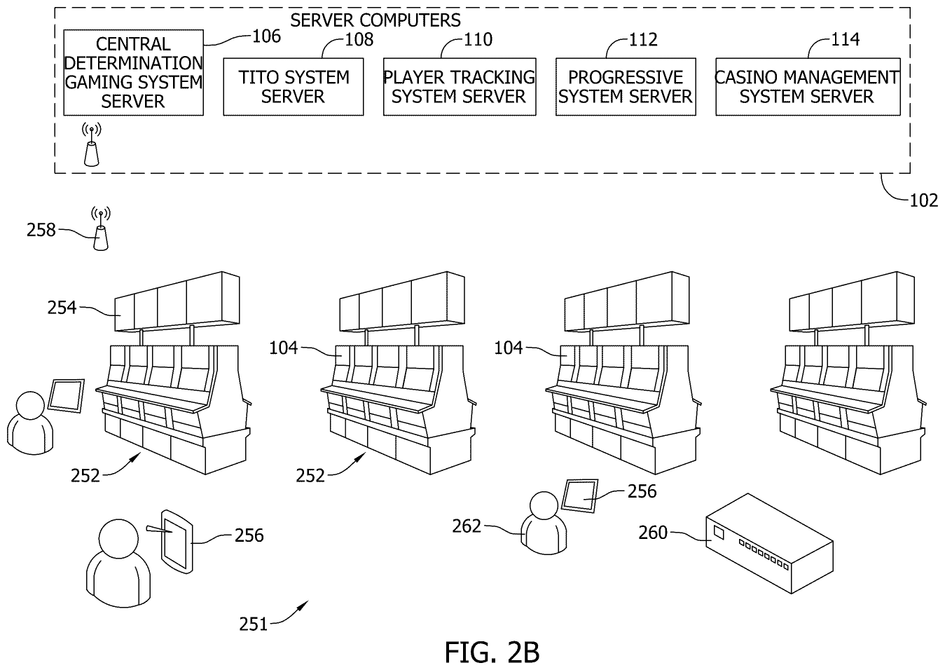

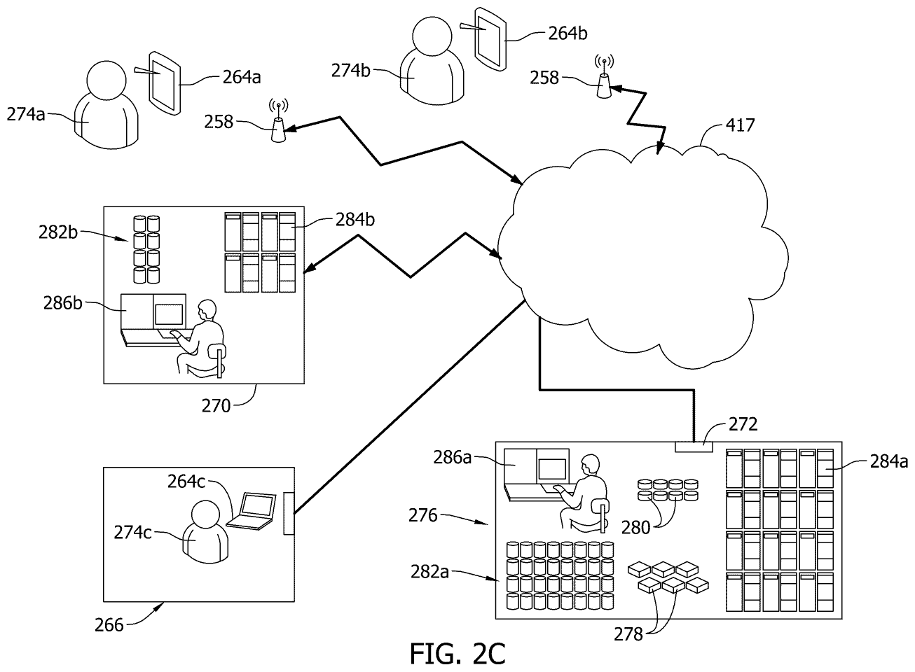

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the Arc™ model gaming device manufactured by Aristocrat® Technologies, Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Gaming device 104C includes a main display 128A that is in a landscape orientation. Although not illustrated by the front view provided, the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. Player tracking interface 232 may include a keypad 226 for entering information, a player tracking display 228 for displaying information (e.g., an illuminated or video display), a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204, game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include: (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204; and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI)) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM)) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and/or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212, gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more Uis, the game outcome on one or more of the primary game displays 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and/or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding number of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272. In this example, switches 278 and routers 280 are configured to provide network connectivity for devices of the gaming data center 276, including storage devices 282a, servers 284a and one or more workstations 286a. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 417. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

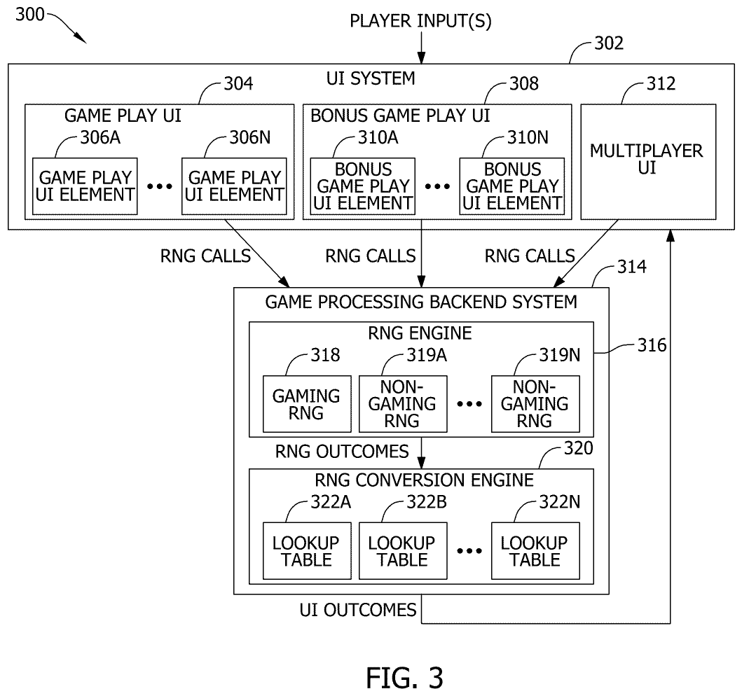

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more Uis that a player can interact with. The UI system 302 could include one or more game play Uis 304, one or more bonus game play Uis 308, and one or more multiplayer Uis 312, where each UI type includes one or more mechanical Uis and/or graphical Uis (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

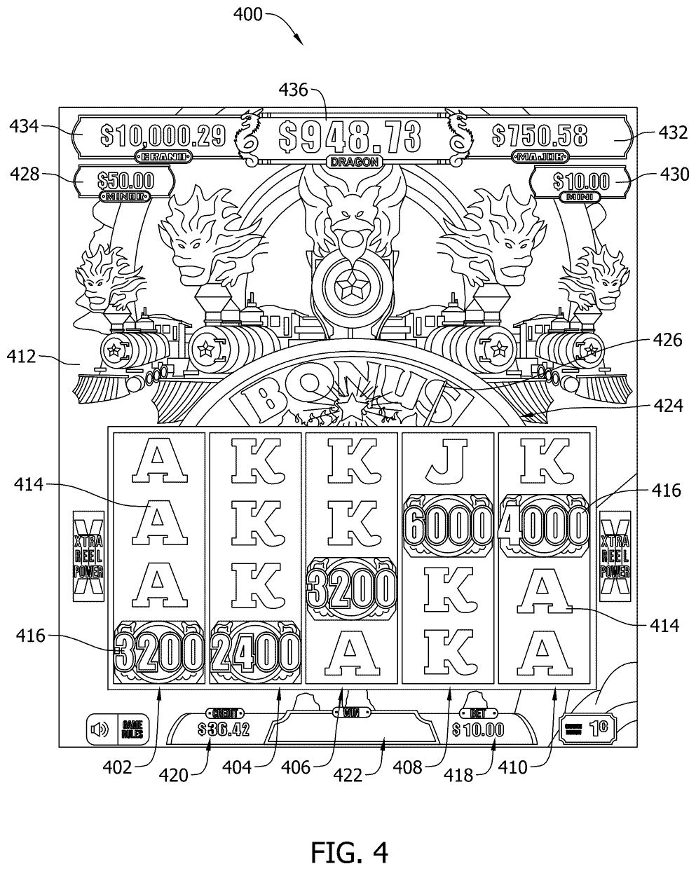

FIG. 4 is an example user interface or screenshot of an example base reel game 400 played on a gaming device (e.g., gaming devices 104A-104X in FIG. 1, and/or gaming device 200 and/or mobile gaming device 256 in FIG. 2). Specifically, FIG. 4 shows a base reel game 400, in which a base reel game outcome is displayed that corresponds to (e.g., presents, represents, and/or is determined from) an output of the gaming device. The output may be a primary game outcome determined in response to a wager received from a player. In example implementations, the primary game outcome is a Class II (e.g., bingo) game outcome or a Class III or Las-Vegas style game outcome. In various implementations, the base reel game 400 may be implemented to present an outcome of any suitable game of chance. Specific details of the type of primary or base reel game outcomes presented using the base reel game 400 are not central to an understanding of the present disclosure. However, additional detail related to at least one implementation (e.g., an implementation employing the base reel game 400 to present a primary bingo-based or Class II game outcome) may be obtained with reference to U.S. Published Patent Application No. 2012/0270638, filed Apr. 20, 2011, and entitled GAMING MACHINE WITH FREE PLAY BONUS MODE PRESENTING ONLY WINNING OUTCOMES, the disclosure of which is hereby incorporated by reference herein in its entirety.

The base reel game 400 may be initiated on a gaming device 104A-104X and 200. Specifically, a player may fund the base reel game 400 via bill validator 234 and/or ticket reader 224. Once funded, the base reel game 400, which includes a first plurality of reels 402, 404, 406, 408, and/or 410, each including a plurality of game symbols 414, may appear on a display 412. The first plurality of reels 402-410 may be physical reels and/or virtual reels. As used herein, physical reels are mechanical in nature and may be physically rotated during gameplay. In contrast, virtual reels are rendered or visually created by game controller 202 on a display, such as primary game display 240, and are merely animated to give the appearance of being spun. The first plurality of reels 402-410 of the example base reel game 400 include five reels. In other examples, the number of reels may range from one reel to five or more reels in number. The base reel game 400 may be played on display 412. However, in other implementations, the base reel game 400 may be played on several displays including display 412 and an additional or auxiliary displays.

The base reel game 400 may be played on several displays, such as the primary display 412 and a secondary display. However, in other implementations, the base reel game 400 may be played on a single display and/or on greater than two displays. In the example shown in FIG. 4, the base reel game 400 includes a first reel matrix on the primary display 412. The first reel matrix includes a plurality of symbol positions arranged in a plurality of rows and a plurality of columns. The first reel matrix may also therefore be referred to as a “matrix of symbol positions.” While, in the example shown in FIG. 4, the first reel matrix is displayed on the primary display 412, the first reel matrix may appear in other locations on an EGM 104A-104X and/or on other displays, such as, for example, the secondary display, a display of button deck 120, and the like.

As described herein, during play of the base reel game 400, game symbols 414 may be selected (e.g., such as from the plurality of reels 402-410) and displayed in the game symbol positions of each column and row of the plurality of reels 402-410. Although not central to an understanding of the present disclosure, each of the plurality of reels 402-410 may include a plurality of game symbols 414 arranged in a vertical column. A number of game symbols 414 of each reel 402-410, corresponding to the number of rows of the plurality of reels 402-410, is displayed in a column of game symbol positions within the plurality of reels 402-410 during play of the base reel game 400. To display symbols from a reel within the plurality of reels 402-410, processor 204 may simulate rotation or spinning of one or more of the plurality of reels 402-410 within a respective column of the plurality of reels 402-410. Here again, however, mechanical reels having physical reel strips may be used as well. When a respective reel is simulated to halt or stop within an associated column, one or more game symbols 414 may be displayed from the reel 402-410 in the game symbol positions of the column. The game symbols 414 displayed after spinning and stopping each reel strip in a respective column of the plurality of reels 402-410 may be referred to herein as a “reel outcome” or a “base reel game outcome” or a “base game outcome.” More broadly, an “outcome” of a reel game, such as a base reel game (e.g., the base reel game 400) refers to the game symbols 414 displayed in the plurality of reels 402-410 after reel strips are spun and stopped. Thus, a rotation and stopping of a plurality of reel strips (also referred to herein as a “spin and stop sequence”) may be simulated by processor 204 within the columns of the plurality of reels 402-410 to cause a reel outcome, including a plurality of game symbols 414, to be displayed from the plurality of reel strips within the columns of the plurality of reels 402-410.

As shown in the exemplary embodiment of FIG. 4, and as discussed herein, the plurality of game symbols 414 included and/or displayed within the plurality of reels 402-410 include and/or are formed from various symbol types. For example, graphic game symbols of the plurality of game symbols 414 include predetermined graphics, symbols, and/or art works that can be based on a theme, story, and/or visual representation of base reel game 400. Additionally, or alternatively, graphic game symbols include suitable graphics, symbols, and/or artworks commonly associated with gaming device (e.g., “BAR,” “SPIN,” “WILD,” etc.). The plurality of game symbols 414 also include cash-on-reel (COR) symbol 416 displayed within the plurality of reels 402-410. COR symbols 416 include, display, depict, and/or are associated with a predetermined credit value (e.g., COR credit value) that can provide additional award credits to the player during base reel game 400 and/or define credit values for the bonus event, as discussed herein.

Base reel game 400 also includes a wager meter 418, and a credit meter 420 depicted on display 412. Wager meter 418 represents and/or displays the credit and/or monetary value being wagered during each play of base reel game 400, as determined by the player. Credit meter 420 displays a credit balance (calculated as a sum total of credits input and awards accrued minus wagers placed) accrued until a player cashes out. A win meter 422 is also displayed in base reel game 400. As discussed herein, win meter 422 displays a credit and/or monetary value awarded during outcomes of the bonus event.

A bonus event indicator or meter 424 (hereafter, “bonus event indicator 424”) is also displayed in base reel game 400. Bonus event indicator 424 provides a visual representation and/or illustration indicating how close a player is to triggering the bonus event. More specifically, bonus event indicator 424 includes a visual graphic displayed on display 412 to dynamically indicate and/or represent to a player of base reel game 400 whether or not they are likely to trigger the bonus event. In exemplary embodiments shown in FIG. 4, bonus event indicator 424 includes a movable and/or animated needle 426 and the word “BONUS.” As more triggering events occur during base reel game 400, as discussed herein, needle 426 of bonus event indicator 424 moves from left to right to represent that a player is getting closer to triggering the bonus event. Additionally, or alternatively, each letter of the word “BONUS” can become illuminated and/or highlighted as needle 426 passes over them, in order to provide additional representation of the likelihood that the bonus event is going to occur and/or be triggered. In the exemplary embodiment shown, needle 426 is not in a right most position of bonus event indicator 424, and/or all of the letters of the word “BONUS” are not illuminated (e.g., “S” is partially illuminated). As such, bonus event indicator 424 of base reel game 400 shown in FIG. 4 indicates to the player that at least one bonus event has not been triggered. Although discussed herein including a needle and/or illuminable words, it is to be understood that bonus event indicator 424 can be formed and/or displayed as any suitable visual indicator including, but not limited to, a fillable bar, or a metamorphic animation.

In operation, the reel outcome presented during play of the base reel game 400 (e.g., base reel game outcome) corresponds to, presents, represents, and/or is determined from a primary game outcome. For example, the reel outcome (base reel game outcome) may correspond to a primary or underlying Class II game, or the reel outcome may be determined randomly (e.g., in Class III games). Additionally, and as discussed herein, base reel game outcomes and/or conditions of base reel game 400 trigger the bonus event. For example, a base reel game outcoming displaying three (3) or more COR symbols 416 within the plurality of reels 402-410 can trigger at least one bonus event. Additionally, or alternatively, each time COR symbols 416 are displayed within the plurality of reels 402-410 of base reel game 400, the credit values associated with each COR symbol 416 can be added together and progressively adjust the dynamic visual of bonus event indicator 424. Specifically, each time a COR symbol 416 is displayed in the base reel game outcome for base reel game 400, needle 426 of bonus event indicator 424 can move further right and/or more letters in the word “BONUS” are illuminated. In the exemplary embodiment, the total of the credit values associated and/or displayed with each COR symbol 416 in the outcome(s) of base reel game 400 can trigger at least one bonus event in response to the total exceeding a predetermined threshold, as discussed herein.

In exemplary embodiments, base reel game 400 also displays a plurality of “jackpot” bonuses 428, 430, 432, 434 on display 412. For example, jackpot bonus 428 includes a “mini” jackpot value, jackpot bonus 430 includes a “minor” jackpot value, jackpot bonus 432 includes a “major” jackpot value, and jackpot bonus 434 includes a “grand” jackpot value. As discussed herein, each jackpot bonus 428-434 can correspond to and/or is correlated with at least one bonus event that is triggered by the base reel game outcome of base reel game 400. Additionally, the credit value associated with each jackpot bonus 428-434 may be a predetermined credit value. Alternatively, jackpot bonuses 428-434 include progressive credit values that are dependent upon, at least in part, the credit and/or monetary value being wagered during each play of base reel game 400 (e.g., wager meter 418), the number of consecutive base reel games 400 played prior to triggering the bonus event, and the like.

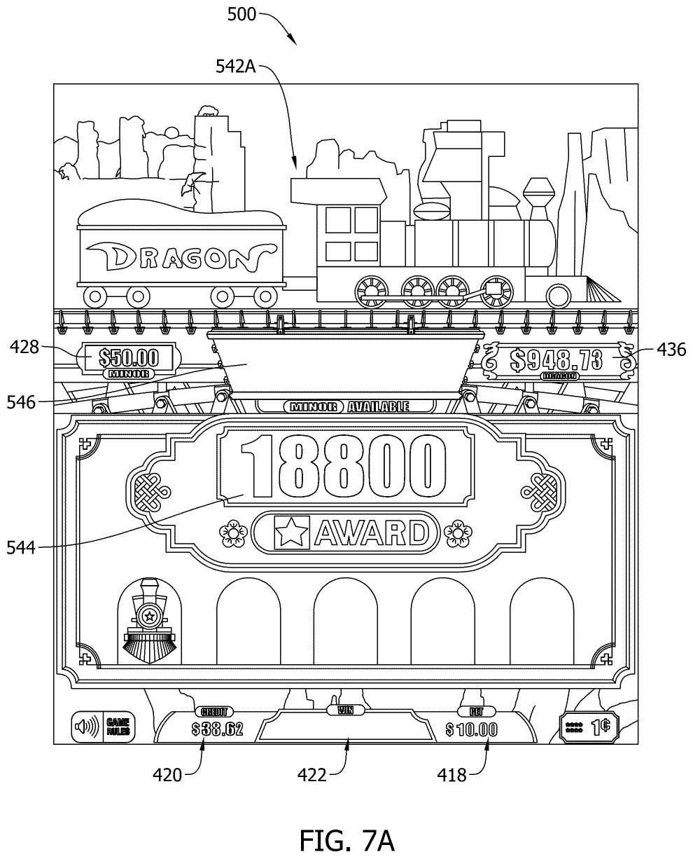

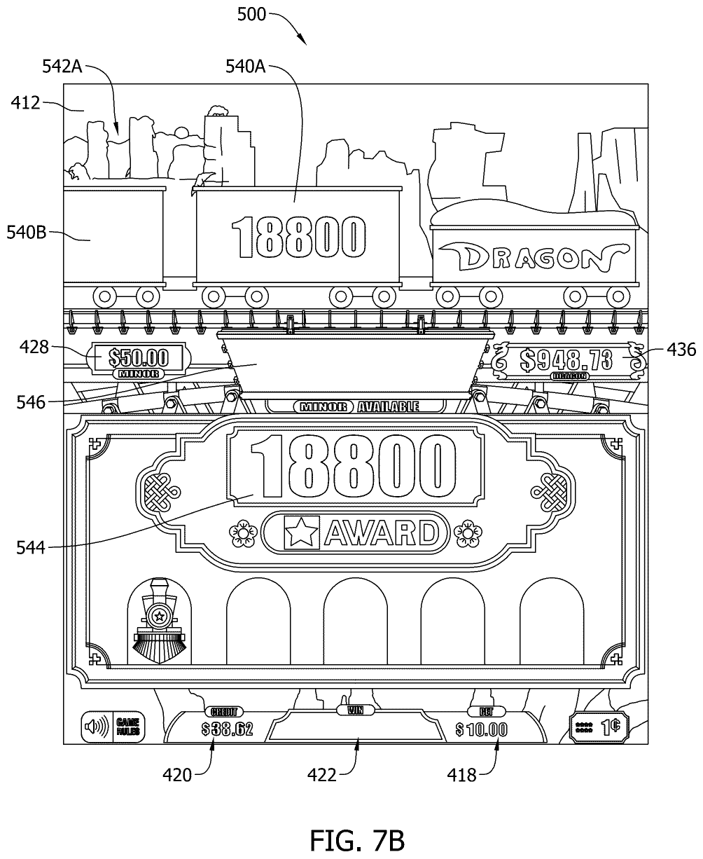

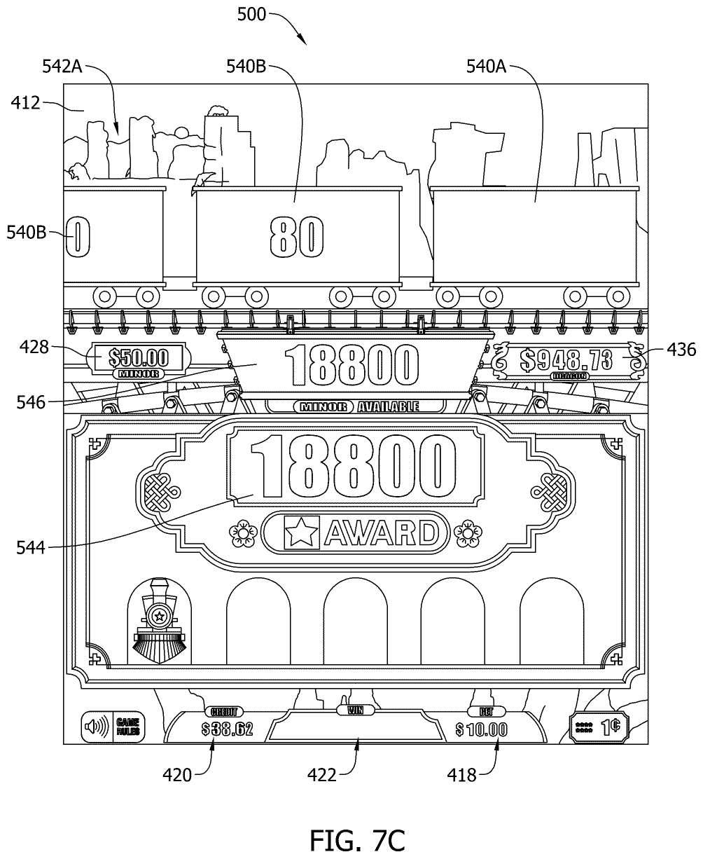

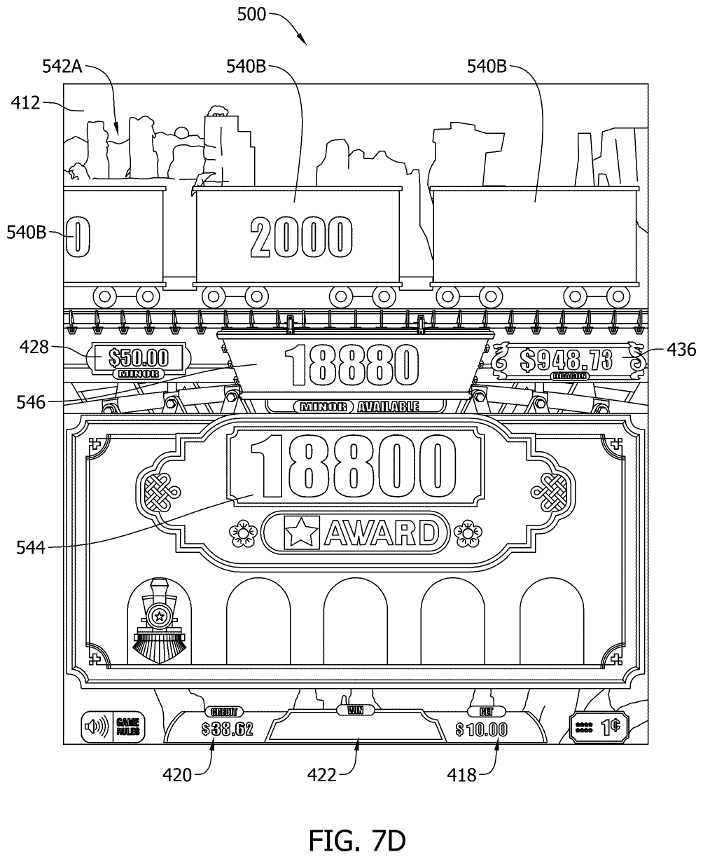

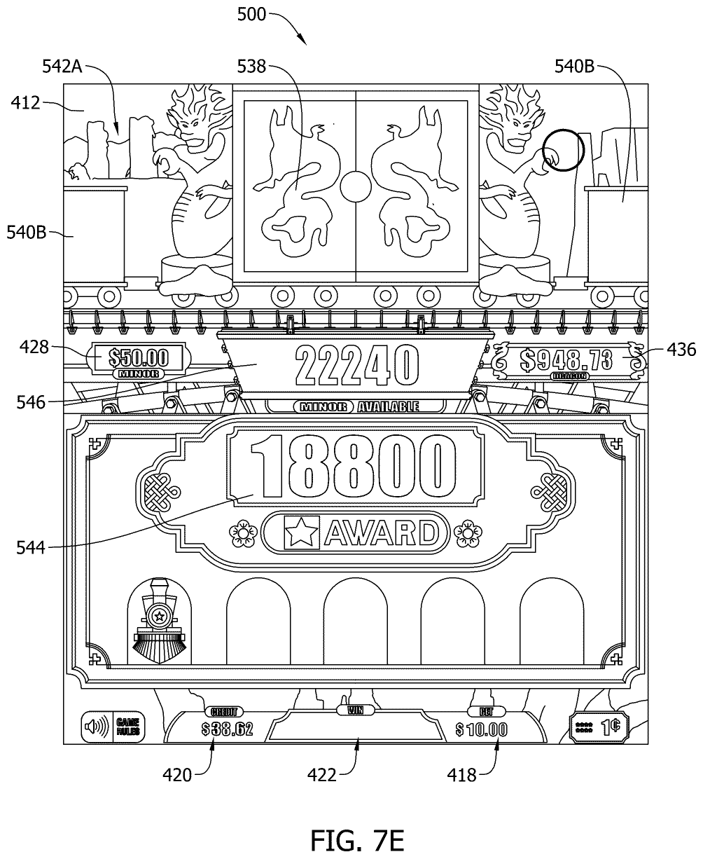

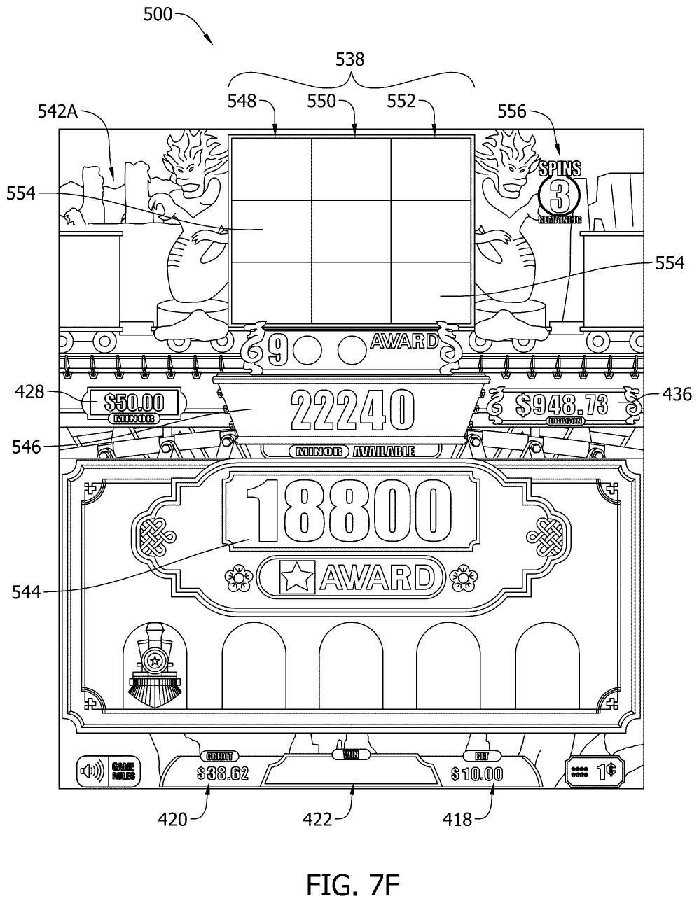

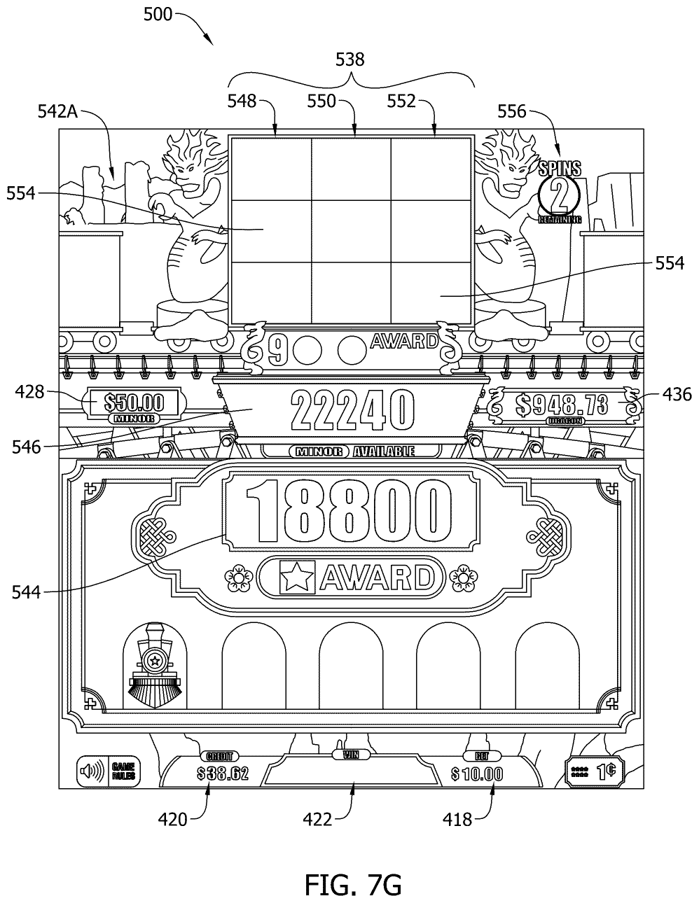

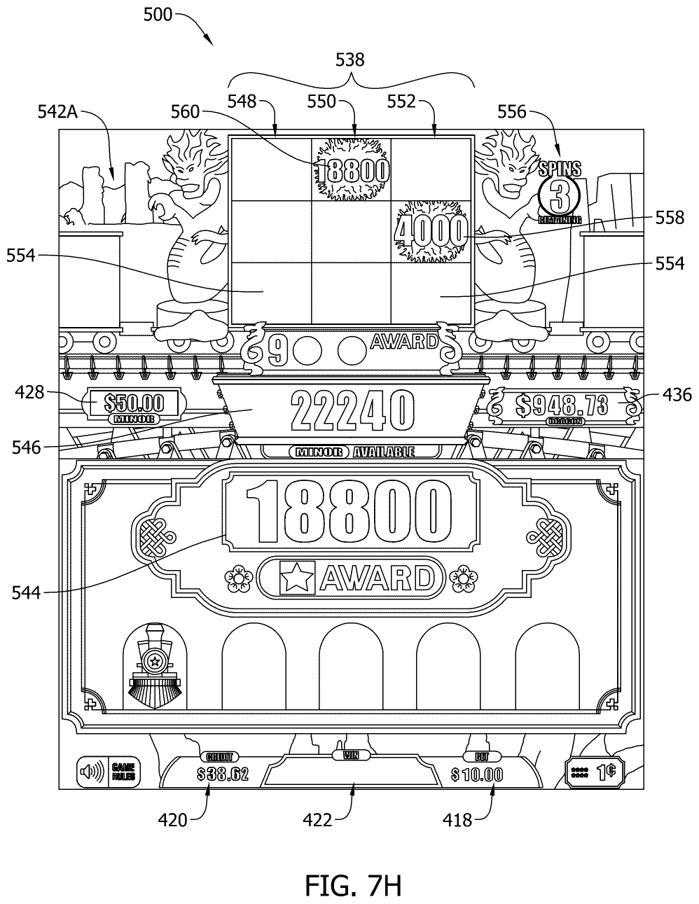

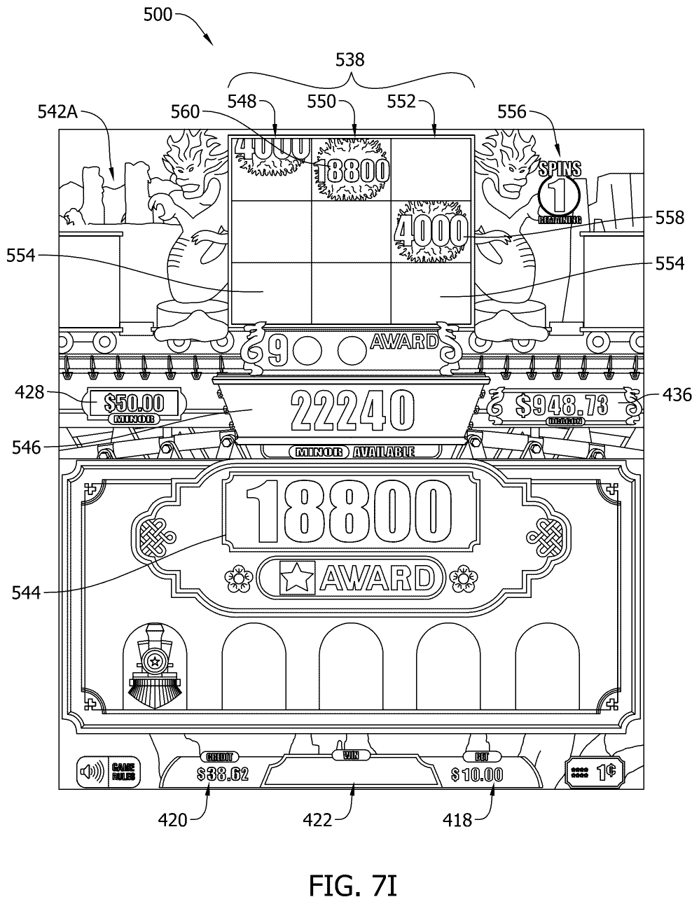

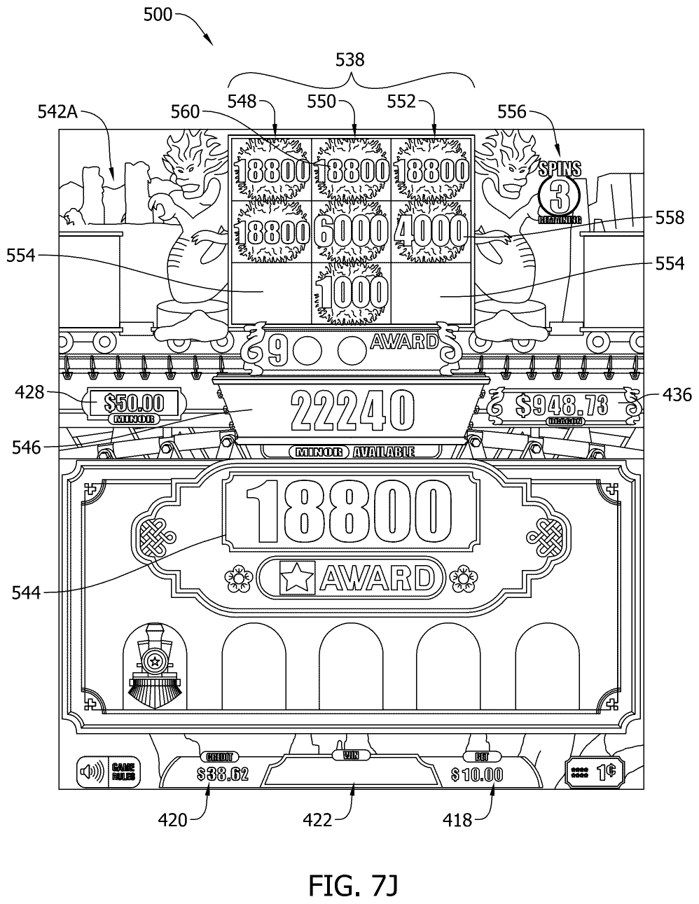

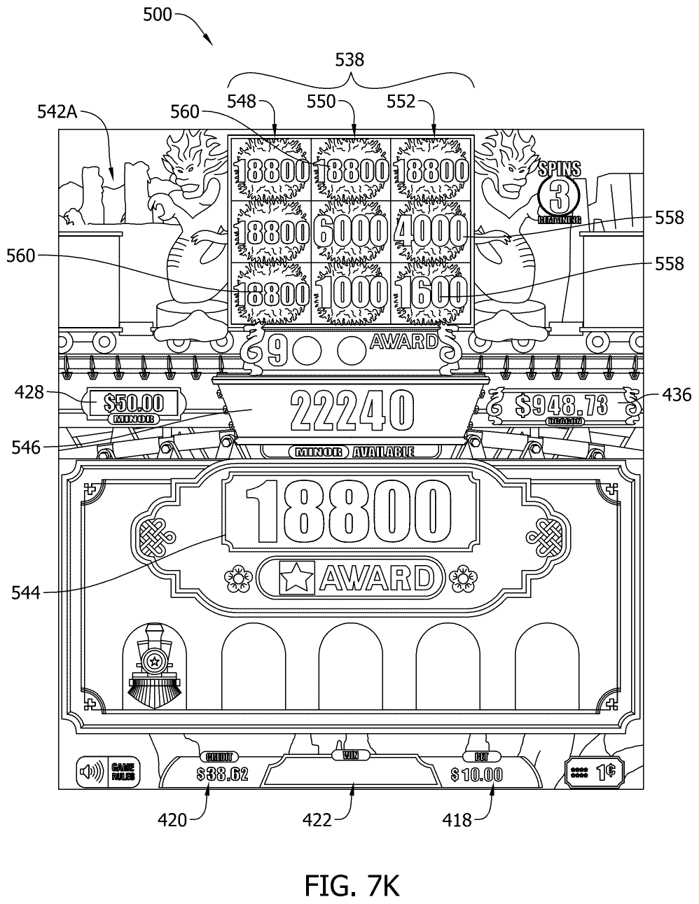

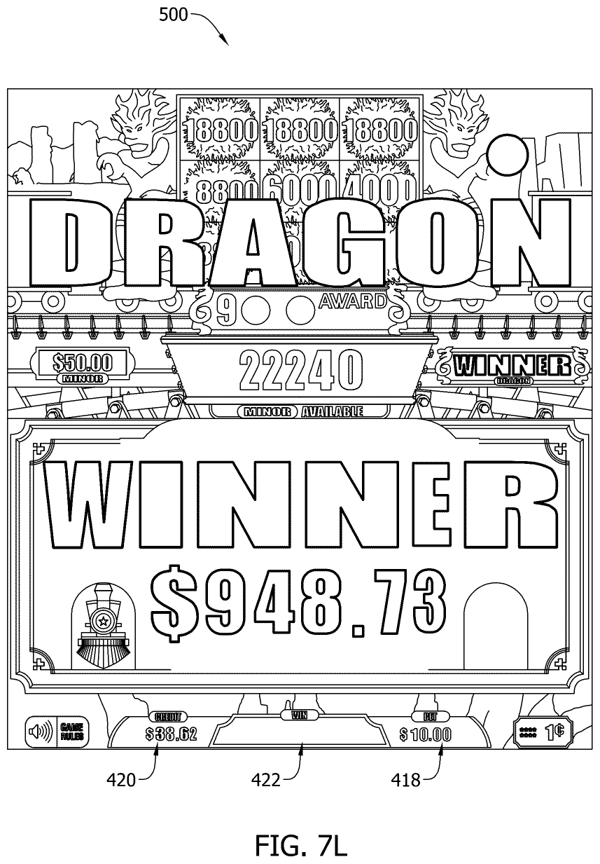

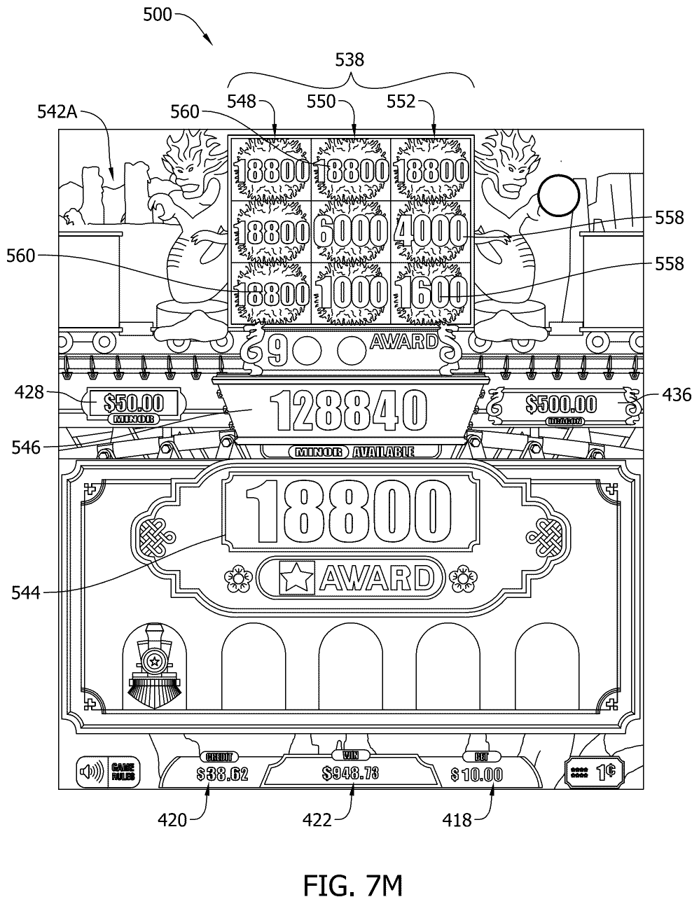

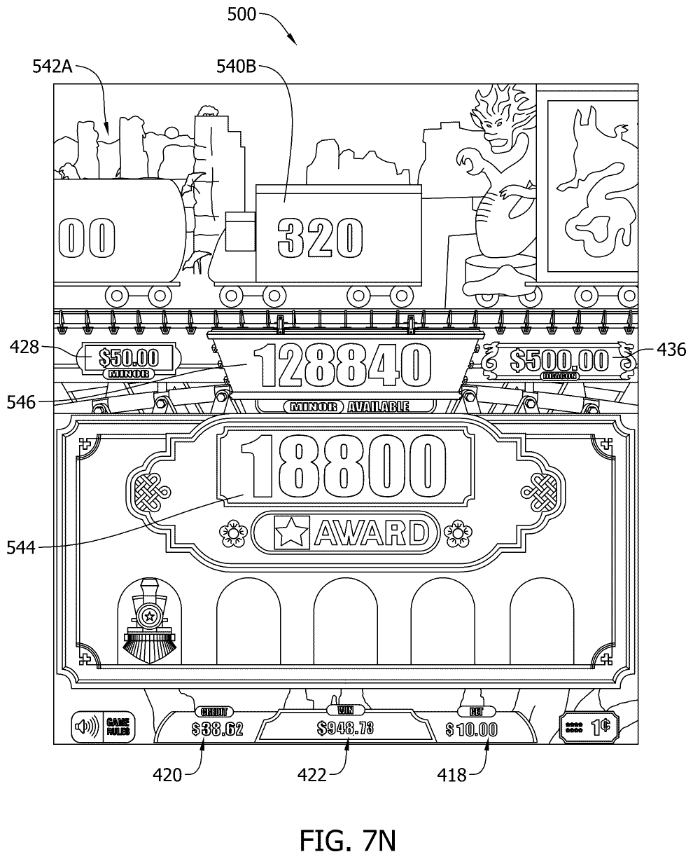

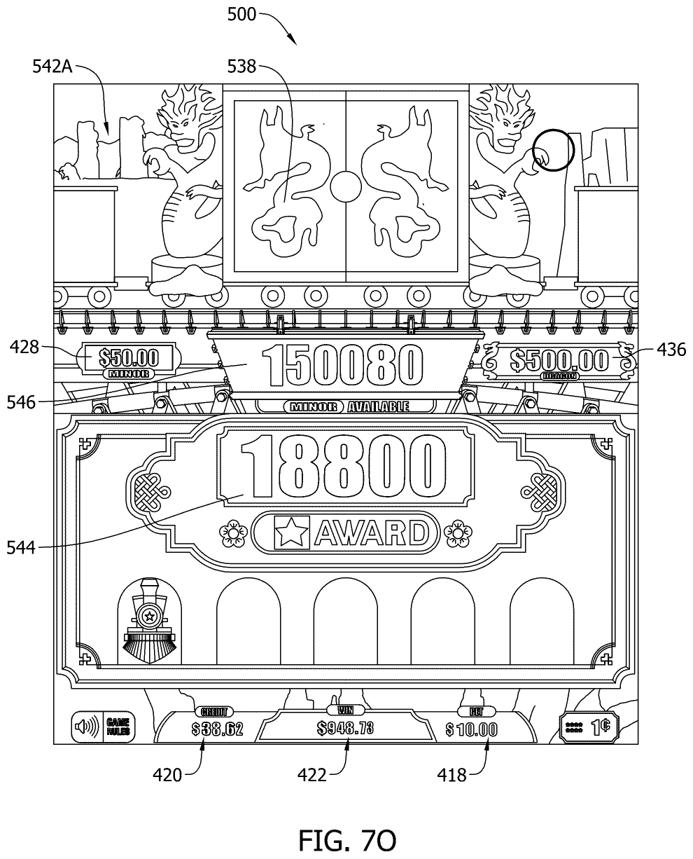

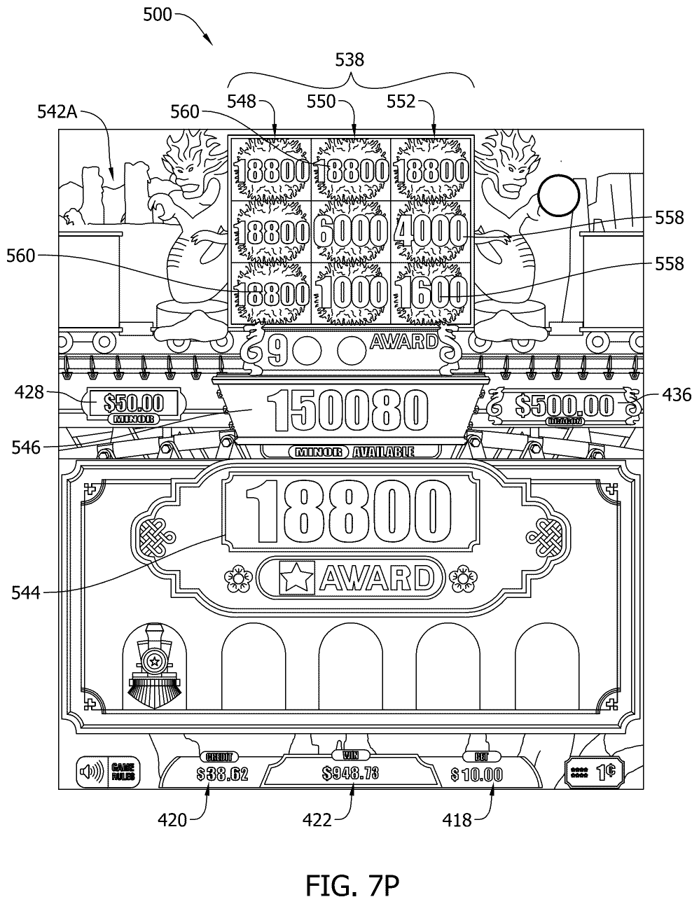

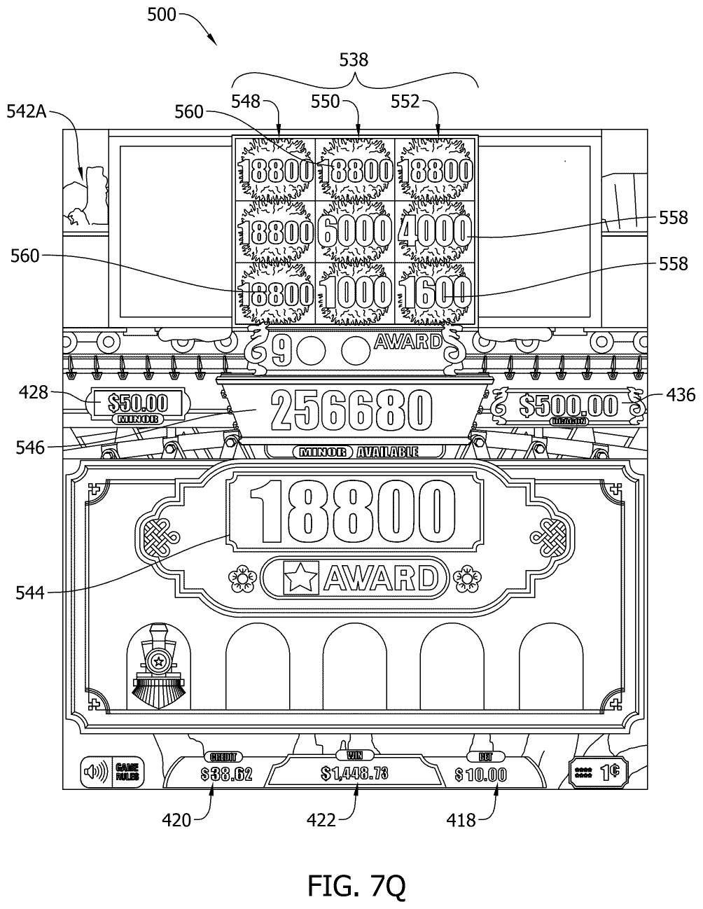

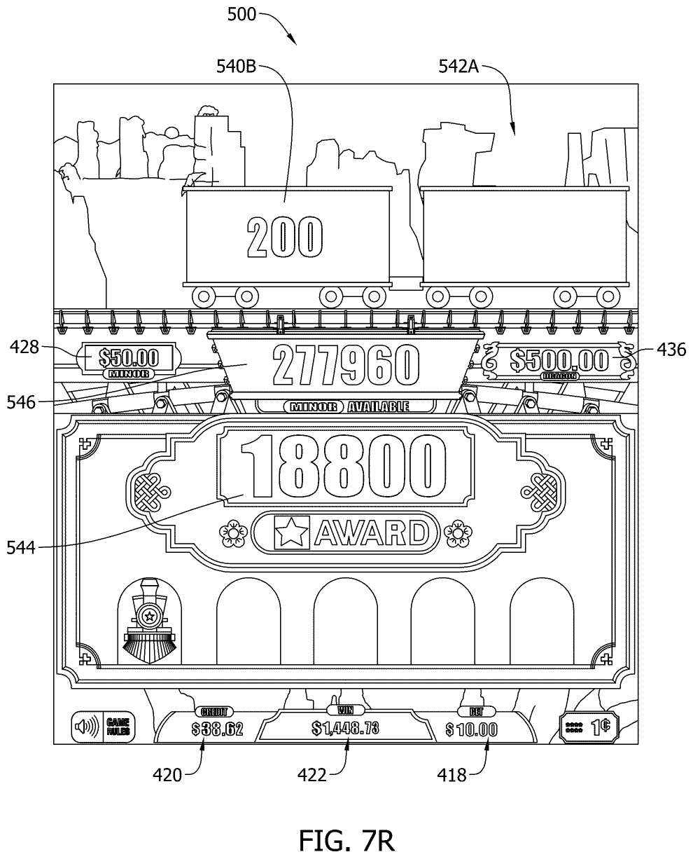

As shown in FIG. 4, base reel game 400 also includes a bonus event jackpot 436. As discussed herein, bonus event jackpot 436 is awarded during the bonus event, and more particularly, during a bonus game occurring during the bonus event (see, FIGS. 7E-7M). Similar to jackpot bonuses 428-434, bonus event jackpot 436 includes a progressive bonus event credit value that can be dependent upon, at least in part, the credit and/or monetary value being wagered during each play of base reel game 400 (e.g., wager meter 418), the number of consecutive base reel games 400 played prior to triggering the bonus event, and the like. Additionally, and as discussed herein, the bonus event credit value for bonus event jackpot 436 also includes a minimum bonus event credit value (see, FIG. 7N) that can be awarded during the bonus event.

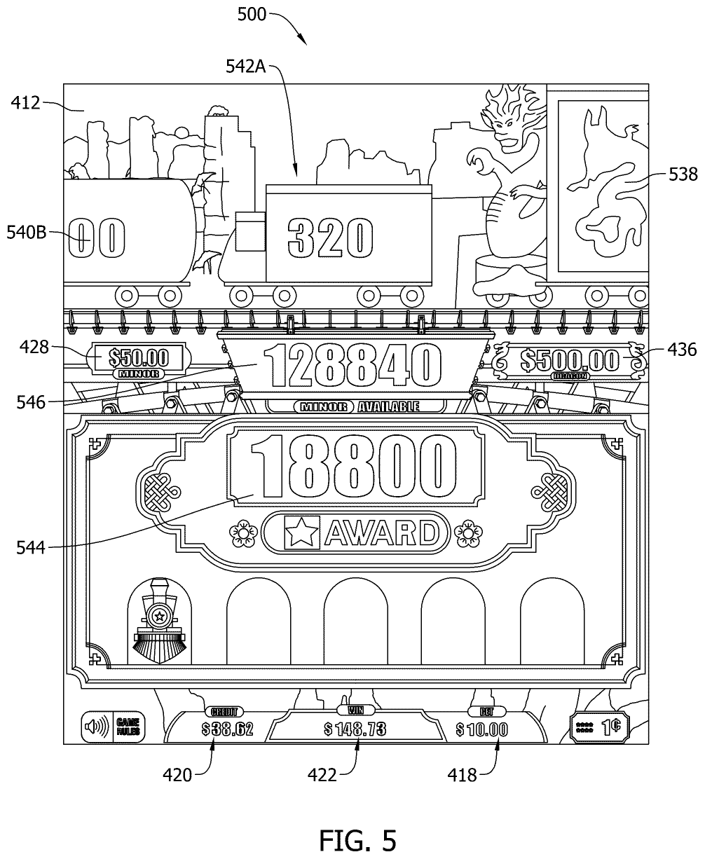

Referring to FIG. 5, an exemplary user interface or screenshot of a bonus event 500 initiated after playing base reel game 400 (see, FIG. 4) is displayed. The bonus event 500 is triggered by the primary game outcome (e.g., base reel game outcome) satisfying a bonus event condition, described in further detail herein. In the example implementation, bonus event 500 may include providing players with the opportunity to play and/or engage with at least one bonus game 538, and/or engage with at least one bonus feature 540. That is, and as discussed herein, bonus event 500 triggered by the outcome of base reel game 400 provides players with various game experiences and/or interaction that can vary from one another and/or provide distinct outcomes and/or awards for the player. Additionally, and as discussed herein, more than one bonus event 500 can be triggered by the base reel game outcome of base reel game 400. In the exemplary embodiment shown in FIG. 5, bonus event 500, and more specifically bonus game 538 and bonus feature(s) 540, are presented to the player via a graphical train 542A and/or using a train-theme. That is, and as discussed herein, at least one bonus event 500 triggered by base reel game 400 may include a train-theme, where graphical train 542A is one of a plurality of graphic trains that facilitates the displaying and/or presentation of at least one bonus game 538, and/or at least one bonus feature 540 to the player during bonus event 500.

However, it is to be understood that bonus event 500 is not limited to a train or train-theme, and may be implemented as any other suitable, visually appealing theme that can facilitate the displaying and/or presenting of bonus game(s) 538 and/or bonus feature(s) 540, as similarly discussed herein. Additionally as described herein, bonus event 500 is triggered in response to the game controller 202 (e.g., via the processor 204) determining that the primary game outcome satisfies a bonus event condition (e.g., three (3) or more COR symbols 416 displayed in single base reel game outcome, total credit value for COR symbols exceeding a threshold, and/or a total award value of a bingo game outcome).

In the exemplary embodiment shown in FIG. 5, bonus event 500 continues to display wager meter 418, and credit meter 420 on display 412. Furthermore, bonus event 500 also continues to depict win meter 422 on display 412. As discussed herein, win meter 422 displays a credit and/or monetary value awarded during outcomes of bonus event 500 (e.g., outcomes of bonus game(s) 538). Also shown in FIG. 5, jackpot bonus 428 including the “mini” jackpot value continues to be displayed during bonus event 500. In a non-limiting example, jackpot bonus 428 is displayed during bonus event 500 as a result of the selected graphical train 542A for bonus event 500 being associated with and/or providing the player the opportunity to win jackpot bonus 428 during bonus event 500.

Bonus event 500 also includes and/or depicts bonus event jackpot 436. With comparison to bonus event jackpot 436 depicted in base reel game 400 (see, FIG. 4), bonus event jackpot 436 includes a credit value equal to the minimum bonus event credit value (e.g., $500). As discussed herein, bonus event jackpot 436 is reset to the minimum bonus event credit value after predetermined conditions are meet for bonus game(s) 538 of bonus event 500 and/or the bonus event credit value for bonus event jackpot 436 is awarded to the player during bonus event 500.

Additionally in exemplary embodiments, bonus event 500 depicts and/or presents a cumulative credit value 544. Cumulative credit value 544 is based on and/or defined during the base reel game outcome of base reel game 400 (see, FIG. 4). More specifically, cumulative credit value 544 displayed during bonus event 500 is based, at least in part, on the cumulative credit values for COR symbols 416 displayed during base reel game 400, and prior to the triggering of bonus event 500. For example, where the triggering condition for bonus event 500 includes three (3) or more COR symbols 416 being displayed in a single outcome of base reel game 400, cumulative credit value 544 of bonus event 500 is equal to the cumulative or added credit value associated with all COR symbols 416 displayed in the outcome of base reel game 400. Briefly returning to exemplary embodiments shown in FIG. 4, the outcome of base reel game 400 includes five (5) COR symbols 416, where the cumulative or total credit value for all five COR symbols 416 equals “18,800” credit values. As such, the base reel game outcome including five (5) COR symbols 416 triggers bonus event 500 and the “18,800” is displayed in cumulative credit value 544.

In another example, cumulative credit value 544 represents a cumulative credit value for COR symbols 416 included within multiple outcomes for base reel game 400. That is, cumulative credit value 544 is the cumulative credit value for COR symbols 416 that are displayed during multiple spins of the plurality of reels 402-410 during base reel game 400. In this example, “18,800” is the cumulative COR credit value that exceeds threshold (e.g., 18,000 threshold) to trigger bonus event 500, and is achieved as a result of the most recent outcome of base reel game 400 including at least one COR symbol 416, as discussed herein. Cumulative credit value 544 defines aspects of bonus game(s) 538 and/or feature 540 of bonus event 500. For example, and as discussed herein, cumulative credit value 544 represents a credit value of one of the bonus game symbols included within bonus game 538. Additionally, and as discussed herein, cumulative credit value 544 is associated with a distinct bonus feature (see, FIG. 7B) displayed to the player during bonus event 500.

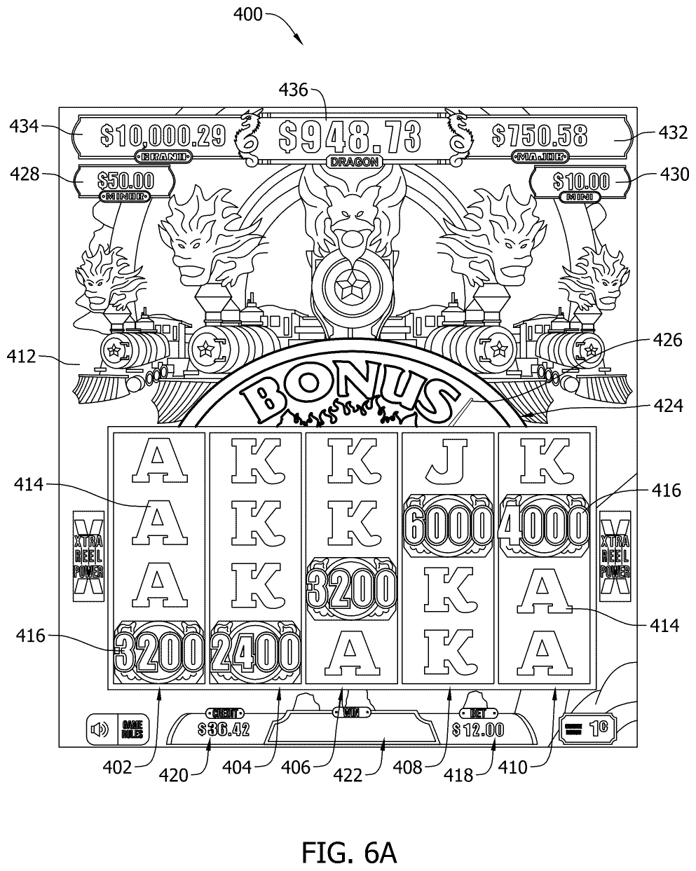

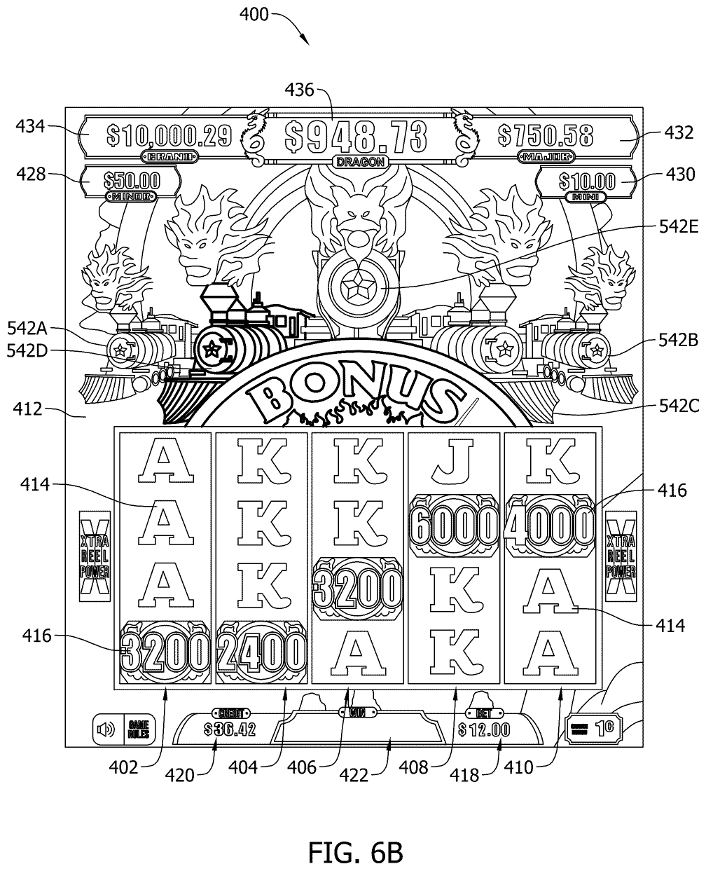

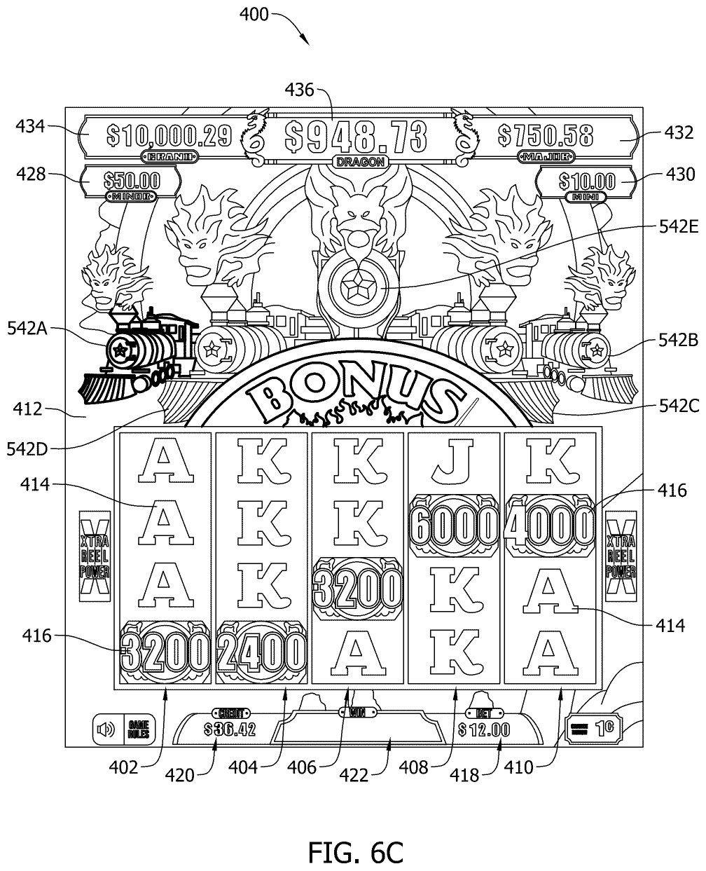

Turning to FIGS. 6A-6C, user interfaces or screen shots of a sequence between base reel game 400 (FIG. 6A) and the bonus event 500 (FIGS. 6B and 6C) are shown. As shown in FIG. 6A, in the displayed base reel game outcome of the base reel game 400, the plurality of reels 402-410 include five (5) COR symbols 416. As discussed herein, the inclusion of three (3) or move COR symbols 416 within a single outcome of base reel game 400 results in at least one bonus event 500 being triggered (see, FIGS. 6B and 6C). In another non-limiting example discussed herein, the cumulative credit value for the five (5) COR symbols 416 displayed in the plurality of reels 402-410 can exceed the bonus event threshold, and thus the outcome of base reel game 400 displayed in FIG. 6A can trigger bonus event 500.

Additionally as shown in FIG. 6A, bonus event indicator 424 may represent and/or identify to the player that bonus event 500 has been triggered based on the outcome of base reel game 400. In the exemplary embodiment, needle 426 is positioned and/or oriented all the way to the right within bonus event indicator 424. Additionally as shown, needle 426 is positioned to the right of the word “BONUS,” and/or each letter of “BONUS” is completely illuminated. In other non-limiting examples, other displayed indications can be provided on display 412 to notify the player that bonus event(s) 500 have been triggered as a result of the outcome of base reel game 400. For example, base reel game 400 and subsequent display of bonus event 500 may be provided in conjunction with a change to an overlaid translucent or transparent colored graphic effect around display 412. For instance, in one implementation, display 412 may change to include a color overlay. The color overlay may be displayed for the duration of bonus event 500 to let a player know they are taking part in bonus events. In other implementations, words, symbols, letters, animations, and/or other visual effects may be displayed on display 412, and/or auxiliary displays, in addition to and/or alternative to bonus event indicator 424.

FIGS. 6B and 6C are user interfaces or screen shots of bonus event 500 initiating on display 412. In the exemplary embodiment shown in FIG. 6B, a plurality of graphical trains 542A, 542B, 542C, 542D, 542E are displayed above the plurality of reels 402-410. As discussed herein, each of the plurality of graphical trains 542A-542E correspond to one of the plurality of jackpot bonuses 428, 430, 432, 434 or bonus event jackpot 436 also depicted on display 412. For example, graphical train 542A corresponds to jackpot bonus 428 (e.g., mini jackpot), graphical train 542B corresponds to jackpot bonus 430 (e.g., minor jackpot), graphical train 542C corresponds to jackpot bonus 432 (e.g., major jackpot), graphical train 542D corresponds to jackpot bonus 434 (e.g., grand jackpot), and graphical train 542E corresponds to bonus event jackpot 436. As discussed herein, where graphical train 542A-542E is selected for inclusion and/or use within bonus event 500, the selected graphical train 542A-542E can provide the player with the opportunity to win or be awarded the corresponding jackpot bonus 428-434 or bonus event jackpot 436.

During the initiation of bonus event 500, at least one graphical train 542A-542E is selected at random. In an exemplary embodiment, each of the plurality of graphical trains 542A-542E are illuminated successively and/or randomly until one (or more) graphical trains 542A-542E are selected for bonus event 500. Bonus event 500 shown in FIG. 6B illustrates a screen shot of display 412 during the selection process where graphical train 542D is illuminated. Conversely, FIG. 6C depicts the end of the random selection process of graphical trains 542A-542E for bonus event 500. In the exemplary embodiment shown in FIG. 6C, graphical train 542A is selected for bonus event 500. As discussed herein with respect to FIGS. 7A-7R, graphical train 542A facilitates the displaying and/or presenting of bonus game(s) 538 and/or bonus feature(s) 540 to the player during bonus event 500.

FIGS. 7A-7R are user interfaces or screen shots of a sequence of bonus event 500 displayed on display 412 for the player. More specifically, FIGS. 7A-7R depict display 412 illustrating one exemplary sequence of bonus event 500 involving graphical train 542A. As shown in FIG. 7A, and subsequent to the random selection of train 542A to facilitate the displaying and/or presenting of bonus game(s) 538 and/or bonus feature(s) 540 to the player during bonus event 500 (see, FIGS. 6B and 6C), the front of train 542A included in bonus event 500 is depicted on display 412. The front of train 542A (e.g., engine and coal car) provides a visual indication and/or representation that bonus event 500 including train 542A has begun. Additionally in exemplary embodiments, an animation of train 542A moving across display 412 during bonus event 500 facilitate the displaying and/or presenting of bonus game(s) 538 and/or bonus feature(s) 540 to the player, as discussed herein.

As shown in FIGS. 7B-7D, train 542A moves across display 412 (e.g., left to right) to display and/or present various bonus feature(s) 540A, 540B included within bonus event 500. In the exemplary embodiment shown in FIG. 7B, a first bonus feature 540A is displayed and/or included with train 542A. First bonus feature 540A includes and/or displays a credit value equal to the cumulative credit value 544 defined during the base reel game, prior to the triggering of bonus event 500, and depicted on display 412. As shown, the credit value (e.g., “18800”) of first bonus feature 540A is displayed and/or animated as an illustrative boxcar, train car, and/or carriage (hereafter, “carriage”) of train 542A moves during bonus event 500. Turning to FIG. 7C, once the carriage of first bonus feature 540A moves past a predetermined point in display 412 (e.g., halfway point), the credit value corresponding to and/or displayed on first bonus feature 540A is awarded and/or added to a bonus event credit meter 546. In an exemplary embodiment, the credit value displayed in first bonus feature 540A may be “removed” from first bonus feature 540A and/or animated to move from first bonus feature 540A to bonus event credit meter 546. In another non-limiting example, the credit value for first bonus feature 540A remains displayed on first bonus feature 540A as train 542A moves within display 412, and the credit value of first bonus feature 540A is added to bonus event credit meter 546.

Bonus event credit meter 546 is dynamically adjusted as bonus event 500 continues during the game play. That is, as additional bonus feature(s) 540A, 540B and/or bonus game 538 (see, FIG. 7E) are displayed and/or presented during bonus event 500, the credit value depicted in bonus event credit meter 546 may be continuously adjusted until bonus event 500 ends. For example, and with reference to FIGS. 7C and 7D, a second bonus feature 540B is displayed and/or included with train 542A (see, FIG. 7C). Second bonus feature 540B includes and/or displays a random credit value. That is, and distinct from the credit value for first bonus feature 540A corresponding to cumulative credit value 544, second bonus feature 540B includes a randomly generated and/or determined credit value to be displayed. As shown, the credit value (e.g., “80”) of second bonus feature 540B is displayed and/or animated as a carriage of train 542A moves during bonus event 500.

Turning to FIG. 7D, and similar to first bonus feature 540A, once the carriage of second bonus feature 540B moves past a predetermined point in display 412 (e.g., halfway point), the credit value corresponding to and/or displayed on second bonus feature 540B is awarded and/or added to bonus event credit meter 546. Similar to first bonus feature 540A, the credit value displayed on second bonus feature 540B may be “removed” and/or animated to move from second bonus feature 540B to bonus event credit meter 546, or alternatively, the credit value for second bonus feature 540B remains displayed on the carriage of second bonus feature 540B. Additionally as shown in FIG. 7D, the credit value displayed in bonus event credit meter 546 is adjusted to include the credit value associated with second bonus feature 540B. For example, the “80” credit value for second bonus feature 540B is added to the “18800” credit value included in first bonus feature 540A, such that bonus event credit meter 546 is dynamically adjusted to display a credit value of “18880” in FIG. 7D.

In exemplary embodiments, a plurality of first bonus feature 540A and/or second bonus feature 540B can be displayed and/or presented during bonus event 500. That is, train 542A can include and/or display a plurality of first bonus feature 540A and/or second bonus feature 540B over the course of bonus event 500 being presented to the player. For example, and as shown in FIG. 7D, train 542A of bonus event 500 includes a distinct, second bonus feature 540B having or displaying a random credit value of “2000.” The distinct, second bonus feature 540B can be subsequently displayed and/or presented during bonus event 500 after second bonus feature 540B including the random credit value of “80” is displayed and added to bonus event credit meter 546.

It is to be understood that bonus event 500 can include any number and/or any combination of first bonus features 540A and/or second bonus feature 540B depicted on display 412. Additionally, first bonus features 540A and/or second bonus feature 540B included in train 542A of bonus event 500 can be displayed prior to, and/or subsequent to the first instance of displaying the bonus game 538 (see, FIG. 7E), and prior to, and/or subsequent to any subsequent instance of displaying the bonus game 538 (see, FIG. 7O). As discussed herein, credit values added to bonus event credit meter 546 by first bonus feature 540A and/or second bonus feature 540B during bonus event 500 can be added to credit meter 420 and/or win meter 422 at the conclusion of bonus event 500.

FIGS. 7E-7M are exemplary user interfaces or screen shots of a portion of the sequence of bonus event 500 in which bonus game 538 is displayed and/or presented to the player. As shown in FIG. 7E, bonus game 538 is displayed and/or animated as a distinct bonus game carriage of train 542A that stops on display 412 when being played. That is, train 542A including bonus game carriage corresponding to bonus game 538 temporarily stops moving on display 412 when bonus game 538 is presented during bonus event 500. In the exemplary embodiments, the first instance in which bonus game 538 is presented during bonus event 500 can be the first bonus game 538 is displayed on display 412. As discussed herein, subsequent instances of displaying (or redisplaying) bonus game 538 may occur after the first instance in which bonus game 538 is displayed during bonus event 500.

As shown in FIG. 7F, bonus game 538 includes a plurality of bonus game reels 548, 550, 552. The plurality of reels 548-552 of bonus game 538 form three distinct reels and/or three columns. Each reel 548-552 also includes a predetermined number of rows as well. In the example, the number of predetermined number of rows is also three. As a result, in the example embodiment, the plurality of reels 548-552 for bonus game 538 include a 3×3×3 arrangement, as depicted on display 412, and include sixteen (16) bonus game symbol positions. In other implementations, the plurality of reels 548-552 may be any size/uniformity (e.g., 2×2, 3×3, 4×4, 10×10, etc.), and a number of game symbol positions for the plurality of reels 548-552 may vary depending upon a number of rows and columns of the plurality of reels 548-552. Each row of the plurality of reels 548-552 may be designated by a row number (e.g., “1,” “2,” “3,” etc.). Each column of the plurality of reels 548-552 may be designated by a column letter (e.g., “A,” “B,” “C,” “D,” “E,” etc.). Each bonus game symbol position of the plurality of reels 548-552 may therefore be designated by a symbol position identifier comprising a row number (e.g., “1,” “2,” “3,” etc.) and a column letter (e.g., “A,” “B,” “C,” “D,” “E,” etc.). For example, the upper-left-most bonus game symbol position, occurring at the intersection of row 1 and column A, may be designated by the game symbol position identifier “1A.” In another example, the bottom most game symbol position for reel 552, occurring at the intersection of row 3 and column C, may be designated by the bonus game symbol position identifier “3C.”

During bonus game 538, each of the plurality of bonus game reels 548-552 display a bonus symbol (see, 7H) in the bonus game symbol position. For example, the plurality of bonus game reels 548-552 can randomly “spin” and/or display a bonus symbol in each row and/or bonus game symbol position for each of the plurality of bonus game reels 548-552 during bonus game 538. Prior to “spinning” and/or potentially displaying various bonus symbols, each of the plurality of bonus game reels 548-552 can display and/or include a blank symbol 554 of the bonus symbols. In the exemplary embodiment shown in FIG. 7F, blank symbol 554 of the bonus symbols can be included and/or displayed within each bonus game symbol position (e.g., rows and columns) for the plurality of reels 548-552 for bonus game 538. Blank symbol 554 of the bonus symbols does not include, display, and/or present any credit value that is awarded to the player during bonus game 538. As discussed herein, additional bonus symbols (e.g., bonus cash-on-reel (COR) symbol, cumulative COR symbols) include credit values that, when displayed in bonus game 538, are subsequently awarded to the player during bonus event 500.

Additionally as shown in FIG. 7F, during bonus game 538, a spin number indicator 556 may be displayed and/or presented to the player of bonus event 500. Prior to “spinning” the plurality of bonus game reels 548-552, spin number indicator 556 can display and/or present a predetermined number of bonus spins for bonus game 538 included in bonus event 500. In the exemplary embodiment, the predetermined number of bonus spins for bonus game 538 is three (3)—as displayed in spin number indicator 556.

As discussed herein, the player of bonus event 500 interacts with bonus game 538, and more specifically, “spins” the plurality of bonus game reels 548-552 to display bonus symbols therein. Additionally as discussed herein, the bonus symbols to be displayed in bonus game 538 can include blank symbol 554. Where the player spins and/or causes the plurality of bonus game reels 548-552 to display bonus symbols during bonus game 538, and only blank symbols 554 are displayed after the spin, spin number indicator 556 is reduced by one (1). For example, FIG. 7G depicts bonus game 538 after the player performs a first spin of the predetermined number of bonus spins, and each bonus game reel 548-552 continues to display blank symbols 554. As a result, spin number indicator 556 adjusts the number of spins for bonus game 538 from “3” (see, FIG. 7F), to “2.”

FIG. 7H is an exemplary user interface or screen shot of bonus game 538 after the player of bonus event 500 performs a subsequent spin of the plurality of bonus game reels 548-552. That is, FIG. 7H shows bonus game 538 after a second bonus spin, following the first bonus spin in which only blank symbols 554 were displayed in the plurality of bonus game reels 548-552 (see, FIG. 7G). Subsequent to the second bonus spin, the plurality of bonus game reels 548-552 display and/or present bonus symbols including a bonus cash-on-reel (COR) symbol 558, and a cumulative COR symbol 560. More specifically, bonus game symbol position “2C” displays COR symbol 558 including a bonus COR credit value. Similar to second bonus feature 540B included in train 542A, COR symbol 558 includes and/or displays a randomly generated and/or determined bonus credit value. As shown, the credit value (e.g., “4000”) of COR symbol 558 is displayed and/or animated within the bonus game symbol position on bonus game reel 552.

Additionally, bonus game symbol position “1B” displays cumulative COR symbol 560. As shown in FIG. 7H, cumulative COR symbol 560 includes a cumulative COR credit value that corresponds to and/or is equal to the cumulative credit defined during base reel game 400 and/or presented on display 412 as cumulative credit value 544. Furthermore, the cumulative COR credit value for cumulative COR symbol 560 is similar and/or identical to the credit value displayed on the carriage of second bonus feature 540B included in train 542A (see, FIG. 7B). As shown, the cumulative credit value (e.g., “18800”) of cumulative COR symbol 560 is displayed and/or animated within the bonus game symbol position on bonus game reel 550.

As shown in FIG. 7H, the respective credit values corresponding to and/or included with COR symbol 558 and cumulative COR symbol 560, respectively, are not instantly added to bonus event credit meter 546. Rather, the credit value for all bonus symbols including COR symbol 558 and/or cumulative COR symbol 560 are added to bonus event credit meter 546 after all bonus spins have been performed during bonus game 538, or alternatively after each row for each of the plurality of bonus game reels 548-552 include one of COR symbol 558 or cumulative COR symbol 560.

Additionally, each spin in which one of COR symbol 558 or cumulative COR symbol 560 lands or is displayed on at least one bonus game reel 548-552 of bonus game 538 resets the spin number indicator 556 back to the predetermined number of bonus spins for bonus game 538. In the exemplary embodiment shown in FIG. 7H, and with comparison to FIG. 7G, as a result of both COR symbol 558 and cumulative COR symbol 560 being displayed in bonus game reels 550, 552 of bonus game 538, spin number indicator 556 is reset back to three (3) spins (e.g., predetermined number of bonus spins), prior to the player performing the next spin on bonus game 538. In another non-limiting example, the number of bonus spins are not reset in response to displaying COR symbol 558 or cumulative COR symbol 560 during bonus game 538. Rather, the player can spin bonus game 538 the predetermined number of bonus spins (e.g., three spins), before the first instance of bonus game 538 ends.

FIG. 7I is an exemplary user interface or screen shot of bonus game 538 after the player of bonus event 500 performs additional spins of the plurality of bonus game reels 548-552. As shown in FIG. 7I, two (2) subsequent bonus spins of the plurality of bonus game reels 548-552 are performed, as indicated by the one (1) in spin number indicator 556. As discussed herein, the two subsequent bonus spins do not yield and/or display additional COR symbol 558 and/or cumulative COR symbol 560 in bonus game 538. However, and as shown in FIG. 7I, COR symbol 558 in bonus game symbol position “2C” and cumulative COR symbol 560 in bonus game symbol position “1B” remain persistent and/or continue to be displayed within bonus game 538 during the subsequent spins of the plurality of bonus game reels 548-552. More specifically, and during the entirety of the first instance of presenting bonus game 538 to the player, whenever COR symbol 558 or cumulative COR symbol 560 are displayed within the plurality of bonus game reels 548-552, the COR symbol 558/cumulative COR symbol 560 persists and/or is continuously displayed during subsequent spins. Additionally, and as discussed herein, COR symbol 558/cumulative COR symbol 560 previously displayed in bonus game 538 also persist and/or are displayed during subsequent displaying or redisplaying of bonus game 538 at a subsequent instance during bonus event 500.

FIGS. 7J and 7K are exemplary user interfaces or screen shots of bonus game 538 after the player of bonus event 500 performs further spins of the plurality of bonus game reels 548-552. FIG. 7J shows additional spins of bonus game 538, where additional COR symbols 558 and cumulative COR symbols 560 are displayed in the plurality of bonus game reels 548-552 during the first instance of bonus game 538. Furthermore, FIG. 7K show another subsequent spin of bonus game 538, where even more COR symbols 558 and cumulative COR symbols 560 are displayed in the plurality of bonus game reels 548-552 during the first instance of bonus game 538. In the exemplary embodiment shown in FIG. 7K, each row for each of the plurality of bonus game reels 548-552 includes and/or displays COR symbol 558 or cumulative COR symbol 560. As a result of determining that every single row of each of the plurality of bonus game reels 548-552 includes and/or displays COR symbols 558 or cumulative COR symbols 560, the first instance of bonus game 538 for bonus event 500 ends or concludes. However, it is to be understood that the conclusion of the first instance of bonus game 538 does not conclude bonus event 500, as discussed herein.

In response to determining that every single row of each of the plurality of bonus game reels 548-552 includes and/or displays COR symbols 558 or cumulative COR symbols 560, the bonus event credit value associated with and/or displayed in bonus event jackpot 436 is awarded to the player. For example, and with reference to FIG. 7L, display 412 provides and/or presents an animation indicating to the player that they have been awarded bonus event jackpot 436. The bonus event credit value associated and/or displayed in bonus event jackpot 436 is instantly provided to win meter 422, as shown in FIG. 7M. Additionally, and as a result of awarding the player bonus event jackpot 436, the bonus event credit value for bonus event jackpot 436 subsequent to the award is reset to a minimum bonus event value. For example, after the bonus event credit value of $948.73 (e.g., bonus event jackpot 436)(see, FIG. 7K) is awarded to the player and/or transferred to win meter 422, the bonus event credit value for bonus event jackpot 436 is reset to the minimum bonus event credit value of $500.

Additionally as shown in FIG. 7M, each of the credit values associated with COR symbol 558 and cumulative COR symbol 560, as displayed during the first instance of bonus game 538 is added to bonus event credit meter 546. As discussed herein, the credit values displayed with each COR symbol 558 and/or cumulative COR symbol 560 during bonus game 538 are only added to bonus event credit meter 546 when bonus game 538 is complete and/or ended.

Although the first instance of bonus game 538 has ended, bonus event 500 can continue on display 412. For example, FIG. 7N is an exemplary user interface or screen shot of bonus event 500 after the first instance of bonus game 538 has ended. As shown, the bonus game carriage of bonus game 538 is moved to right and/or off-screen, and/or bonus game 538, including all presented COR symbols 558 and/or cumulative COR symbols 560, ceases to be displayed. In the exemplary embodiment, once bonus game 538 ceases to be displayed, additional carriages are displayed and/or presented to the player during bonus event 500. As similarly discussed herein, and subsequent to ceasing the display of bonus game 538 first bonus feature 540A and/or second bonus feature 540B continue to be displayed and/or presented during bonus event 500. As shown in FIG. 7N, a plurality of second bonus features 540B including random credit values are presented on display 412, and the credit values are subsequently added to bonus event credit meter 546.

FIGS. 70-7Q are exemplary user interfaces or screen shots of a second instance in which bonus game 538 is displayed or redisplayed within bonus event 500. In the exemplary embodiments, the second instance in which bonus game 538 is presented during bonus event 500 can be the second bonus game 538 displayed on display 412, after the first instance of displaying bonus game 538 (see, FIGS. 7E-7M). As shown in FIG. 7O, the bonus game carriage displaying bonus game 538 stops on display 412 when bonus game 538 is displayed during the second instance of bonus event 500. When the bonus game carriage “opens,” as shown in FIG. 7P, each row of the plurality of bonus game reels 548-552 displays and/or presents COR symbol 558 or cumulative COR symbol 560. More specifically, in the exemplary embodiment shown in FIG. 7P, and subsequent to the first instance of bonus game 538, the displaying or redisplaying of bonus game 538 for the second instance during bonus event 500 persists in displaying the same COR symbol 558 and/or cumulative COR symbol 560 previous displayed during the first instance of bonus game 538. As such, the bonus symbols including the COR symbol 558 and/or cumulative COR symbol 560 displayed during the second instance are identical to the bonus symbols displayed during the first instance.

Additionally in the exemplary embodiment, and as a result of each and every row of the plurality of bonus game reels 548-552 displaying one of COR symbol 558 or cumulative COR symbol 560, second instance of bonus game 538 ends or concludes. That is, because no bonus game symbol position of the plurality of bonus game reels display a blank symbol 554 (see, FIG. 7F), no bonus spins are available to the player. Similar to the first instance of bonus game 538, display 412 provides and/or presents an animation indicating to the player that they have been awarded bonus event jackpot 436 again. The bonus event credit value associated and/or displayed in bonus event jackpot 436 is instantly provided to win meter 422, as shown in FIG. 7Q. Additionally, and as a result of awarding the player bonus event jackpot 436, the bonus event credit value for bonus event jackpot 436 subsequent to the award is maintained at the minimum bonus event value (e.g., $500). For example, after the minimum bonus event credit value of $500 (e.g., bonus event jackpot 436) is awarded to the player and/or transferred to win meter 422, as shown in FIG. 7Q, the bonus event credit value for bonus event jackpot 436 is maintained the minimum bonus event credit value of $500. Also shown in FIG. 7Q, each of the credit values associated with COR symbol 558 and cumulative COR symbol 560, as displayed during the second instance of bonus game 538 is once again added to bonus event credit meter 546.

FIG. 7R is an exemplary user interface or screen shot of an end or completion of bonus event 500. As shown, and subsequent to the second instance of bonus game 538 and ceasing to redisplay bonus game 538 after the second instance, additional carriages are displayed and/or presented to the player during bonus event 500. As shown in FIG. 7R, a second bonus feature 540B, configured or represented as a caboose or end car to train 542A, is displayed and/or presented during bonus event 500. In the exemplary embodiment, no additional carriages for first bonus feature 540A and/or second bonus feature 540B may follow the caboose for train 542A. As such, the credit value for the final second bonus feature 540B is added to bonus event credit meter 546, and bonus event 500 ends.

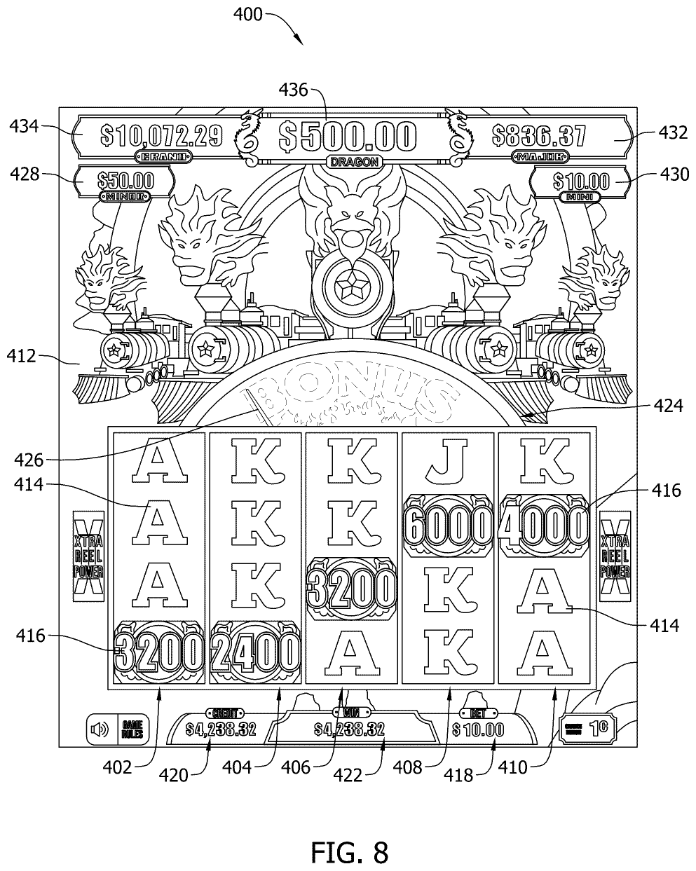

FIG. 8 is an exemplary user interface or screen shot of base reel game 400 following the end of bonus event 500. As shown in FIG. 8, win meter 422 has compiled and/or accumulated all winnings or awards that were presented during bonus event 500. More specifically, win meter 422 includes the credit values associated with all bonus event jackpot 436 (e.g., all rows and reels of bonus game 538), as well as the credit value included and/or added to bonus event credit meter 546 during bonus event 500. As discussed herein, reverting back to base reel game 400 results in the plurality of reels 402-410 and bonus indicator 424 being displayed or presented on display 412.

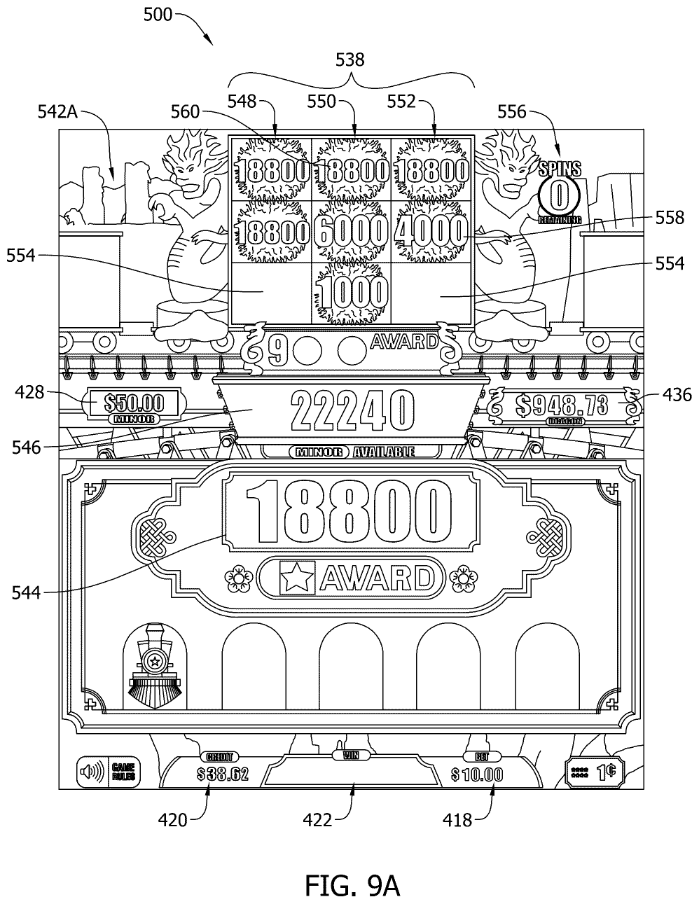

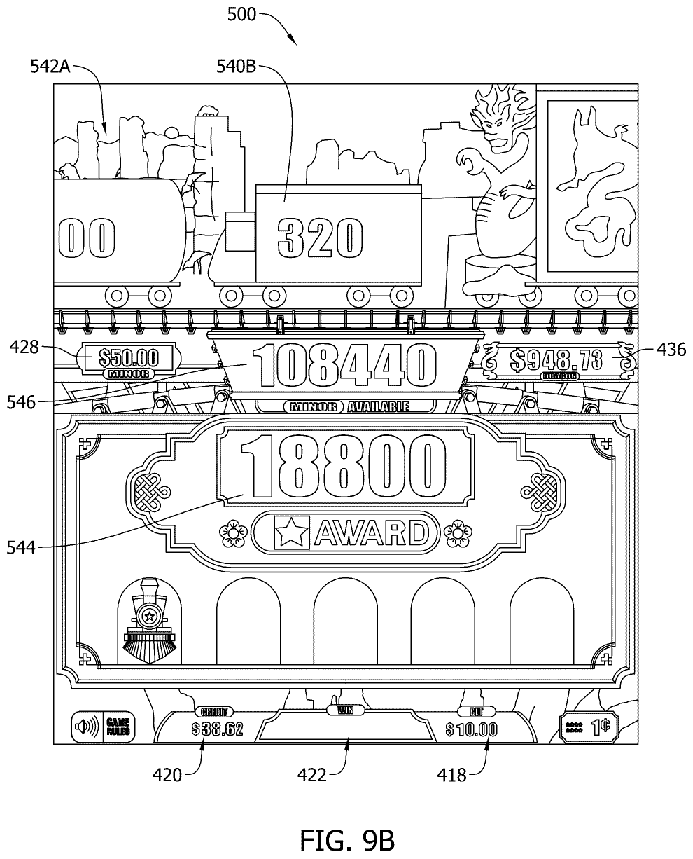

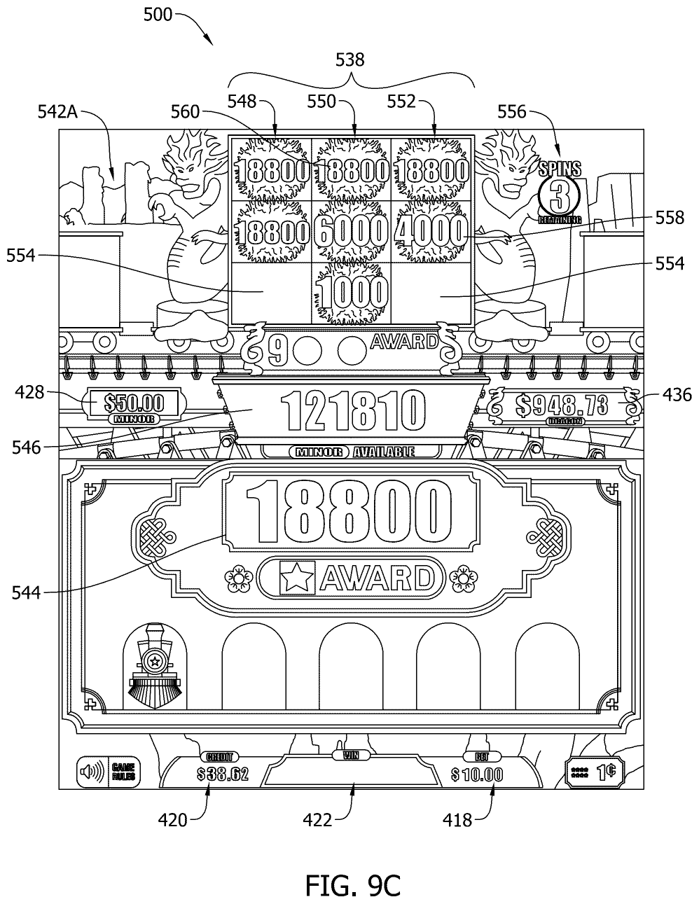

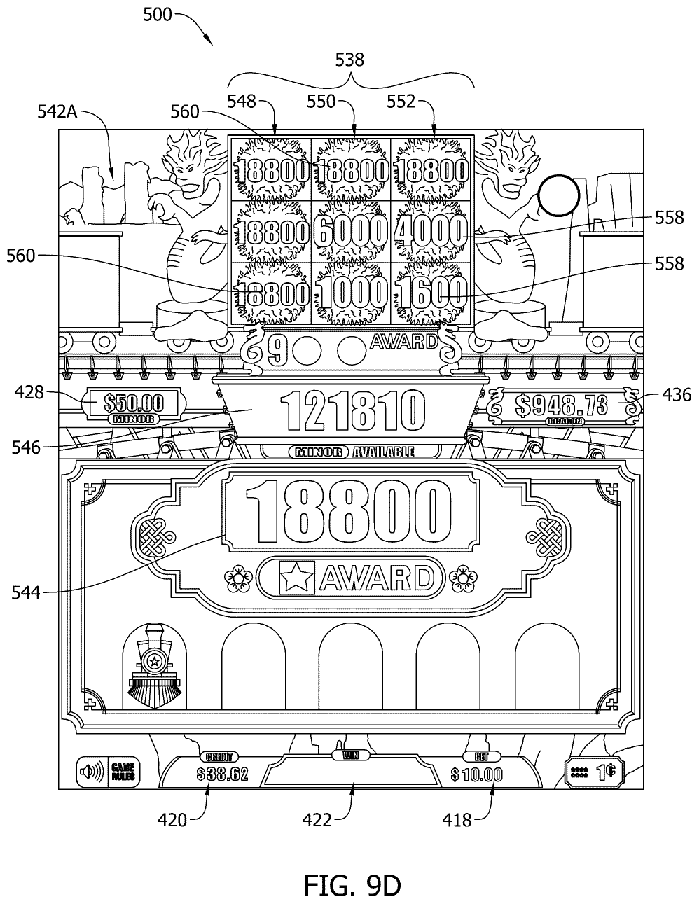

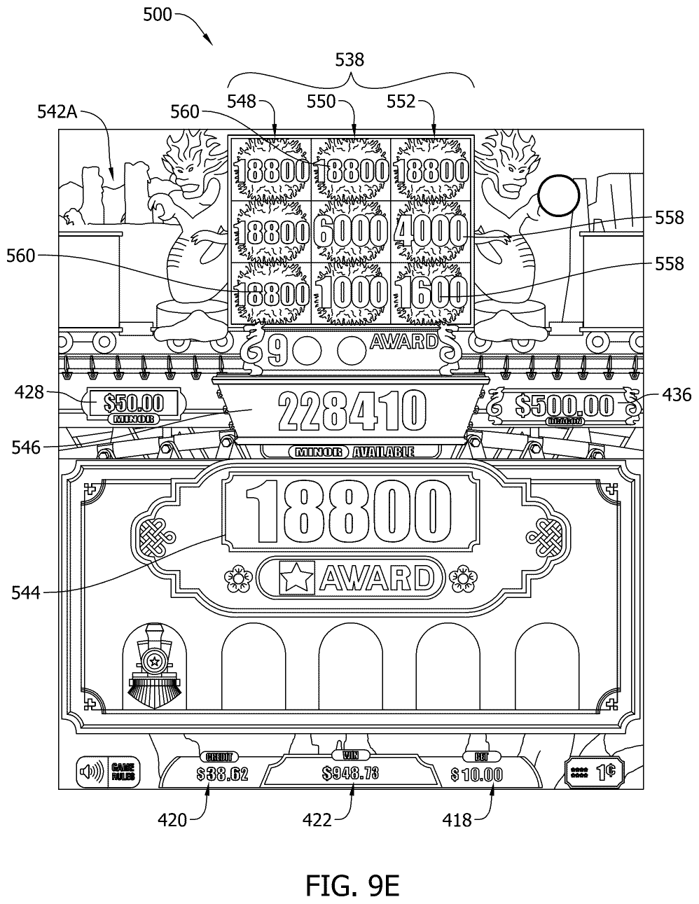

FIGS. 9A-9E are exemplary embodiments of user interfaces or screen shots of a sequence of bonus event 500 displayed on display 412 for the player. Distinct from the sequence discussed herein with respect to FIGS. 7A-7R, the first instance of bonus game 538 does not result in each row of the plurality of bonus game reels 548-552 displaying or presenting COR symbols 558 or cumulative COR symbols 560. For example, FIG. 9A shows bonus game 538 after all bonus spins have been performed. More specifically, FIG. 9A depicts bonus games 538 after all bonus spins have been performed and for three consecutive spins (e.g., the predetermined number of bonus spins), no new COR symbols 558 or cumulative COR symbols 560 were displayed on the plurality of bonus game reels 548-552. As a result, the first instance of bonus game 538 ends. As similarly described herein, the bonus game outcome for the first instance of bonus game 538 includes the total of each of the credit values associated with COR symbol 558 and cumulative COR symbol 560, as displayed in bonus game 538. The bonus game outcome is added to bonus event credit meter 546. Additionally distinct from the sequence discussed herein with respect to FIGS. 7A-7R, because at least one row of the plurality of bonus game reels 548-552 included or displayed blank symbol 554 at the end of the first instance of bonus game 538, the bonus event credit value corresponding to bonus event credit meter 546 is not awarded to the player.

Bonus event 500 continues after ceasing the display of the first instance of bonus game 538. For example, and as shown in FIG. 9B, additional carriages are displayed and/or presented to the player during bonus event 500. That is, subsequent to ceasing the display of bonus game 538 first bonus feature 540A and/or second bonus feature 540B continue to be displayed and/or presented during bonus event 500. As shown in FIG. 9B, a plurality of second bonus features 540B including random credit values are presented on display 412, and the credit values are subsequently added to bonus event credit meter 546. In exemplary embodiments, bonus event 500 can conclude and/or end after the first instance of displaying bonus game 538. That is, bonus event 500 can include only a single instance of bonus game 538. Additionally, or alternatively, where at least one of the bonus game symbol positions of the plurality of bonus game reels 548-552 displays blank symbol 554 (see, FIG. 9A), bonus game 538, and in turn bonus event 500, can end without displaying COR symbols 558 and/or cumulative COR symbols 560 in each bonus game symbol position. In the example, credit values associated with COR symbols 558 and/or cumulative COR symbols 560 displayed during the first (and only) instance of bonus game 538 are awarded at the end of bonus game 538, but bonus event jackpot 436 is not awarded during bonus game 538 and/or bonus event 500, as discussed herein.

FIGS. 9C-9E are exemplary user interfaces or screen shots of a second instance in which bonus game 538 is displayed or redisplayed within bonus event 500. In the exemplary embodiments, the second instance in which bonus game 538 is presented during bonus event 500 can be the second bonus game 538 displayed on display 412, after the first instance of displaying bonus game 538 (see, FIG. 9A). When the bonus game carriage “opens,” as shown in FIG. 9C, and subsequent to the first instance of bonus game 538, the displaying or redisplaying of bonus game 538 for the second instance during bonus event 500 persists in displaying the same COR symbol 558 and/or cumulative COR symbol 560 previous displayed during the first instance of bonus game 538. As such, the bonus symbols including the COR symbol 558 and/or cumulative COR symbol 560 displayed during the second instance are identical to the bonus symbols displayed at the end of the first instance of bonus game 538.

Additionally in the exemplary embodiment, and as a result at least one bonus game reel 548-552 displaying blank symbol 554, second instance of bonus game 538 may continue with bonus spins. That is, and as displayed in spin number indicator 556, the second instance of bonus game 538 provides the player an additional opportunity for bonus spins to display and/or present COR symbols 558 and/or cumulative COR symbols 560 in the positions of the bonus game reels 548-552 that display blank symbol 554.

As similarly discussed herein, and as shown in FIG. 9D, the player may spin the plurality of bonus game reels 548, 552 displaying blank symbol 554 to display and/or present COR symbols 558 and/or cumulative COR symbols 560. In the exemplary embodiment, and in response to determining that every single row of each of the plurality of bonus game reels 548-552 includes and/or displays COR symbols 558 or cumulative COR symbols 560, the bonus event credit value associated with and/or displayed in bonus event jackpot 436 is awarded to the player. For example, and with reference to FIG. 9E, the bonus event credit value associated and/or displayed in bonus event jackpot 436 is instantly provided to win meter 422. Additionally, and as a result of awarding the player bonus event jackpot 436, the bonus event credit value for bonus event jackpot 436 subsequent to the award is reset to a minimum bonus event value. For example, after the bonus event credit value of $948.73 (e.g., bonus event jackpot 436) is awarded to the player and/or transferred to win meter 422, the bonus event credit value for bonus event jackpot 436 is reset to the minimum bonus event credit value of $500.

Additionally as shown in FIG. 9E, each of the credit values associated with COR symbol 558 and cumulative COR symbol 560, as displayed during the first instance of bonus game 538 is added to bonus event credit meter 546. As discussed herein, the credit values displayed with each COR symbol 558 and/or cumulative COR symbol 560 during bonus game 538 are only added to bonus event credit meter 546 when bonus game 538 is complete and/or ended.

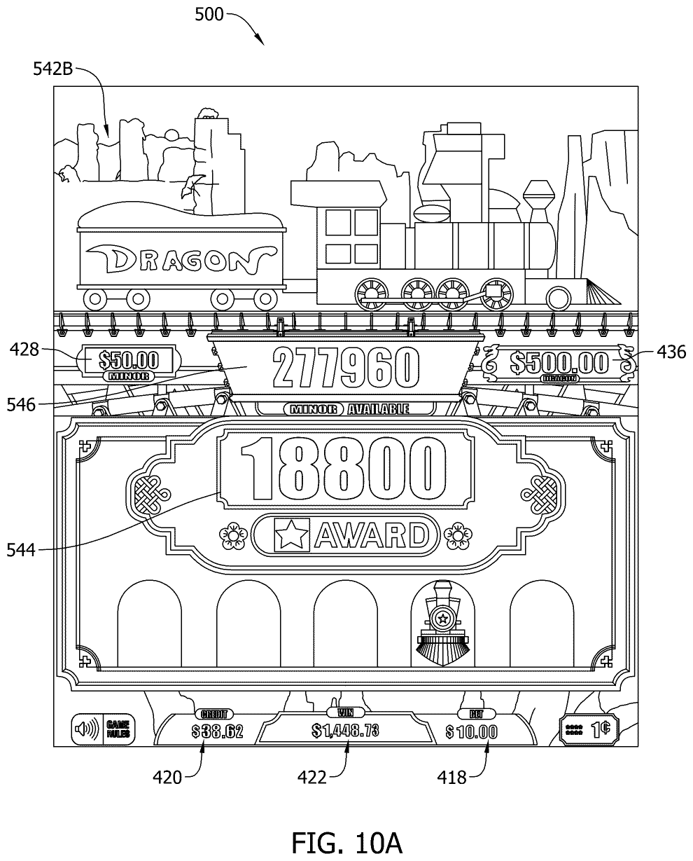

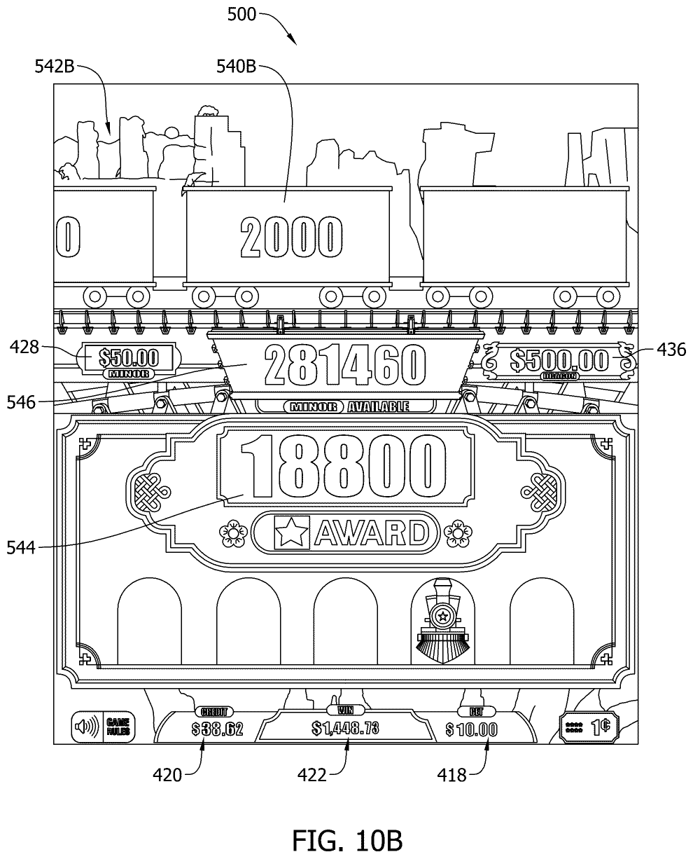

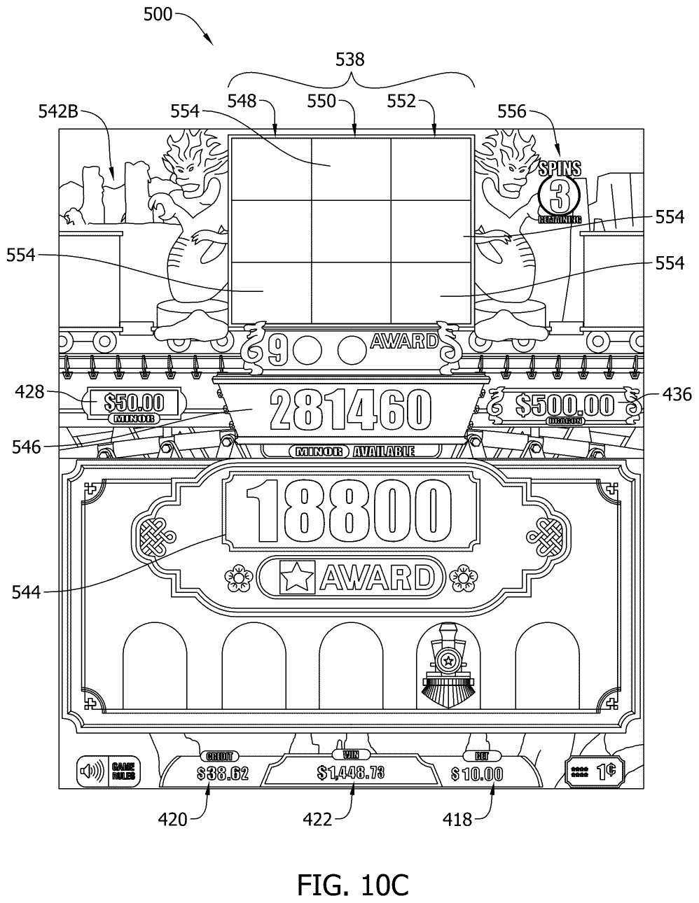

FIGS. 10A-10C are exemplary embodiments of user interfaces or screen shots of a sequence of bonus event 500 displayed on display 412 including a distinct train 542B. That is, and as discussed herein, bonus event 500 can include the displaying of more than one of the plurality of trains 542A-542E, and in turn, the subsequent displaying of bonus game 538 for additional instances during bonus event 500. In the exemplary embodiment shown in FIG. 10A, a front of distinct train 542B, corresponding to jackpot bonus 430 is depicted on display 412. The front of train 542B (e.g., engine and coal car) provides a visual indication and/or representation that bonus event 500 continues including distinct train 542B. Additionally in exemplary embodiments, and similar to train 542A (see, FIGS. 7A-7R), an animation of train 542B moving across display 412 during continued bonus event 500 to facilitate the displaying and/or presenting of bonus game(s) 538 and/or bonus feature(s) 540 to the player, as discussed herein.

As shown in FIG. 10B, distinct train 542B moves across display 412 (e.g., left to right) to display and/or present various bonus feature(s) 540A, 540B included within bonus event 500. In the exemplary embodiment, second bonus feature 540B is displayed and/or included with distinct train 542B. Second bonus feature 540B includes and/or displays a randomly generated and/or determined credit value. As shown, the credit value (e.g., “2000”) of second bonus feature 540B is displayed and/or animated as a carriage of train 542B moves during bonus event 500. Additionally, as similarly discussed herein, the credit value corresponding to and/or displayed on second bonus feature 540B is awarded and/or added to bonus event credit meter 546.

FIG. 10C is an exemplary user interface or screen shot of a bonus game 538 included in distinct train 542B for bonus event 500. As shown in FIG. 10C, bonus game 538 included and/or displayed on train 542B is displayed in a third instance of bonus event 500, subsequent to the second instance of displaying bonus game 538 on train 542A (see, FIG. 7O). In the exemplary embodiment, displaying bonus game 538 on distinct train 542B and/or during the third instance of bonus event 500, results in each row of each of the plurality of bonus game reels 548-552 displaying blank symbol 554. That is, where bonus event 500 includes the displaying of a plurality of distinct trains 542A, 542B, bonus game 538 for the second or distinct train 542B is reset. As such in the exemplary embodiment shown in FIG. 10C, the COR symbols 558 and/or cumulative COR symbols 560 previously displayed and/or persisted through bonus games 538 on train 542A are not persisted and/or continuously displayed in bonus games 538 displayed on distinct train 542B. Rather, the player of bonus event 500 is provided new bonus spin opportunities to display (new) COR symbols 558 and/or cumulative COR symbol 560 in bonus game 538 included on distinct train 542B.

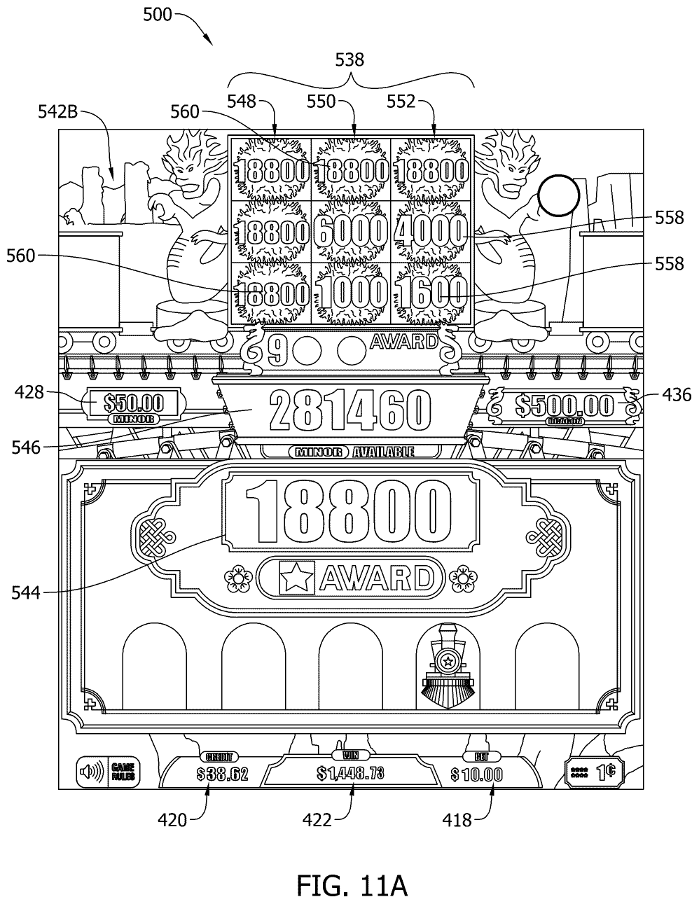

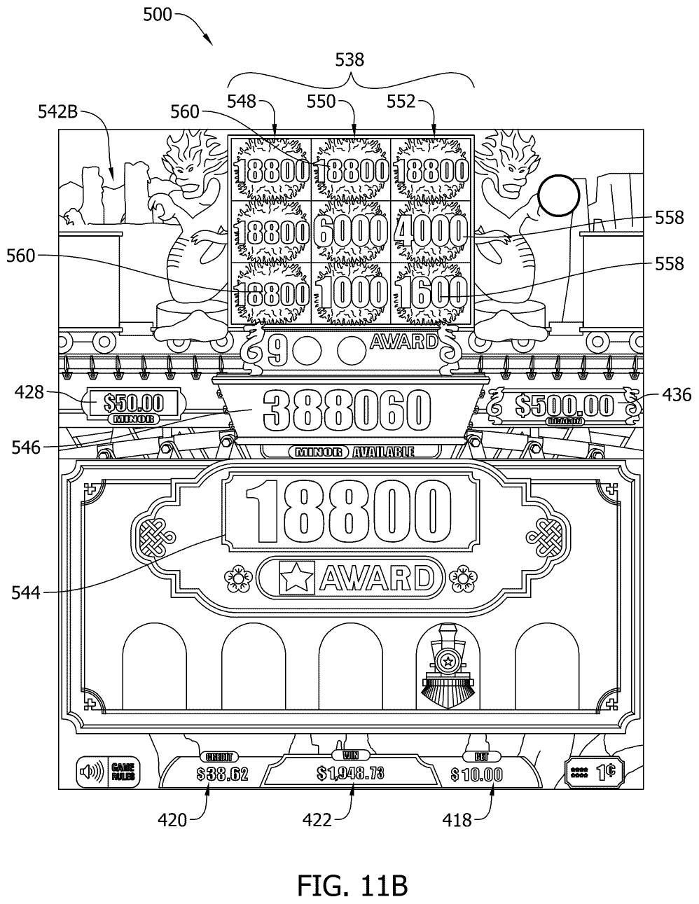

Alternatively, the COR symbols 558 and/or cumulative COR symbols 560 previously displayed and/or persisted through bonus games 538 on train 542A can persist and/or be continuously displayed in bonus games 538 displayed on distinct train 542B. FIGS. 11A and 11B are exemplary user interface or screen shot of a bonus game 538 included in distinct train 542B for bonus event 500. As shown in FIGS. 11A and 11B, bonus game 538 included and/or displayed on train 542B is displayed in a third instance of bonus event 500, subsequent to the second instance of displaying bonus game 538 on train 542A (see, FIG. 7O). In the exemplary embodiment, each row of the plurality of bonus game reels 548-552 displays and/or presents COR symbol 558 or cumulative COR symbol 560. More specifically, and as shown in FIGS. 11A and 11B, and subsequent to the second instance of bonus game 538 being displayed on train 542A, the displaying or redisplaying of bonus game 538 on distinct train 542B for the third instance during bonus event 500 persists in displaying the same COR symbol 558 and/or cumulative COR symbol 560 previous displayed during the second instance of bonus game 538. As such, the bonus symbols including the COR symbol 558 and/or cumulative COR symbol 560 displayed during the third instance are identical to the bonus symbols displayed during the second instance. Additionally, the bonus symbols including the COR symbol 558 and/or cumulative COR symbol 560 displayed in the bonus game 538 included in distinct train 542B are identical to the bonus symbols displayed in the bonus game 538 included in train 542A (see, FIG. 7O).

As similarly discussed herein, and as shown in FIG. 11B, as a result of each and every row of the plurality of bonus game reels 548-552 displaying one of COR symbol 558 or cumulative COR symbol 560, third instance of bonus game 538 ends or concludes. Similar to the first instance and/or second instance of bonus game 538, display 412 provides and/or presents an animation indicating to the player that they have been awarded bonus event jackpot 436 again. The minimum bonus event credit value associated and/or displayed in bonus event jackpot 436 is instantly provided to win meter 422, as shown in FIG. 11B. Additionally, and as a result of awarding the player bonus event jackpot 436, the bonus event credit value for bonus event jackpot 436 subsequent to the award is maintained at the minimum bonus event value (e.g., $500). Also shown in FIG. 11B, each of the credit values associated with COR symbol 558 and cumulative COR symbol 560, as displayed during the third instance of bonus game 538 on distinct train 542B is once again added to bonus event credit meter 546.

A computer, controller, or server, such as those described herein, includes at least one processor or processing unit and a system memory. The computer, controller, or server typically has at least some form of computer readable non-transitory media. As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits “configured to” carry out programmable instructions, and these terms are used interchangeably herein. In the implementations described herein, memory may include, but is not limited to, a computer-readable medium or computer storage media, volatile and nonvolatile media, removable and non-removable media implemented in any method or technology for storage of information such as computer readable instructions, data structures, program modules, or other data. Such memory includes a random access memory (RAM), computer storage media, communication media, and a computer-readable non-volatile medium, such as flash memory. Alternatively, a floppy disk, a compact disc-read only memory (CD-ROM), a magneto-optical disk (MOD), and/or a digital versatile disc (DVD) may also be used. Also, in the implementations described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary implementation, additional output channels may include, but not be limited to, an operator interface monitor.

As indicated above, the process may be embodied in computer software. The computer software could be supplied in a number of ways, for example on a tangible, non-transitory, computer readable storage medium, such as on any nonvolatile memory device (e.g. an EEPROM). Further, different parts of the computer software can be executed by different devices, such as, for example, in a client-server relationship. Persons skilled in the art will appreciate that computer software provides a series of instructions executable by the processor.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising:
at least one memory for storing instructions; and
a game controller in communication with the at least one memory, the game controller including at least one processor, when the instructions are executed by the at least one processor, the at least one processor configured to:
cause to be displayed on a display device a base reel game including a plurality of reels;
determine that an outcome of the base reel game triggers a bonus event; and
control the display device to display the bonus event including:
cause to be displayed on the display device a bonus game in a first instance of the bonus event, the bonus game including a plurality of bonus game reels;
control the plurality of bonus game reels of the bonus game to randomly display one bonus game symbol of a plurality of bonus game symbols in each row for each of the plurality of bonus game reels during a first bonus spin of a predetermined number of bonus spins, the bonus game symbols including a cumulative cash-on-reel (COR) symbol depicting a cumulative COR credit value corresponding to a cumulative credit value defined during the base reel game, prior to the triggering of the bonus event;
in response to at least one row of at least one of the bonus game reels displaying the cumulative COR symbol of the bonus game symbols, continue to cause to be displayed the cumulative COR symbol in the at least one row of the at least one of the bonus game reels during a subsequent bonus spin of the predetermined number of bonus spins; and
cause to redisplay the bonus game on the display device at a second instance of the bonus event, subsequent to the first instance, the redisplayed bonus game persisting to display the cumulative COR symbol as displayed during the first instance of the bonus event.

2. The electronic gaming system of claim 1, wherein the instructions stored in the memory, when executed by the at least one processor, further cause the at least one processor to:
determine a first bonus game outcome for the bonus game displayed during the first instance of the bonus event, the first bonus game outcome including a first total credit value for each bonus game symbol displayed during the first instance of the bonus event; and
determine a second bonus game outcome for the bonus game redisplayed during the second instance of the bonus event, the second bonus game outcome including a second total credit value for each bonus game symbol displayed during the second instance of the bonus event,
wherein the second total credit value is equal to or greater than the first total credit value.

3. The electronic gaming system of claim 2, wherein the instructions stored in the memory, when executed by the at least one processor, further cause the at least one processor to:
determine if each of the rows of the plurality of bonus game reels display the cumulative COR symbol or a bonus cash-on-reel (COR) symbol for the bonus game during the first instance of the bonus event or the second instance of the bonus event, the bonus COR symbol depicting a bonus COR credit value;
in response to each of the rows of the plurality of bonus game reels displaying the cumulative COR symbol or the bonus COR symbol for the bonus game during the first instance of the bonus event:
cause to award the first total credit value; and
cause to award a bonus event credit value; and
in response to each of the rows of the plurality of bonus game reels displaying the cumulative COR symbol or the bonus COR symbol for the bonus game during the second instance of the bonus event:
cause to be awarded the second total credit value; and
cause to be awarded the bonus event credit value.

4. The electronic gaming system of claim 3, wherein in response to each of the rows of the plurality of bonus game reels displaying the cumulative COR symbol or the bonus COR symbol for the bonus game during the first instance of the bonus event, further causing the at least one processor to:
cause to reset the bonus event credit value to a minimum bonus event credit value, the minimum bonus event credit value less than the bonus event credit value;
cause to be awarded the second total credit value subsequent to the redisplaying of the bonus game during the second instance of the bonus event, the second total credit value equal to the first credit value; and
cause to be awarded the minimum bonus event credit value subsequent to the redisplaying of the bonus game during the second instance of the bonus event.

5. The electronic gaming system of claim 1, wherein the instructions stored in the memory, when executed by the processor, further cause the at least one processor to:
cause to be displayed on the display device at least one first bonus feature including a credit value equal to the cumulative credit value defined during the base reel game, prior to the triggering of the bonus event;
cause to be displayed on the display device at least one second bonus feature including a random credit value; and
cause to award at least one of:
the cumulative credit value of each of the displayed first bonus feature, or
the random credit value of each of the displayed second bonus feature.

6. The electronic gaming system of claim 1, wherein the instructions stored in the memory, when executed by the processor, further cause the at least one processor to:
cause to redisplay the bonus game on the display device at a third instance of the bonus event, subsequent to the second instance, the redisplayed bonus game persisting to display the cumulative COR symbol as displayed during the first instance of the bonus event and the second instance of the bonus event.

7. The electronic gaming system of claim 1, wherein the instructions stored in the memory, when executed by the processor, further cause the at least one processor to:
in response to at least one row of at least one of the bonus game reels displaying the cumulative COR symbol, continue to cause to be displayed the cumulative COR symbol in the at least one row of the at least one of the bonus game reels during a subsequent bonus spin of the predetermined number of bonus spins during the first instance of the bonus game.

8. A method of electronic gaming implemented on an electronic gaming machine, the method comprising:
causing to be displayed on a display device a base reel game including a plurality of reels;
determining that an outcome of the base reel game triggers a bonus event; and
controlling the display device to display the bonus event including:
causing to be displayed on the display device a bonus game in a first instance of the bonus event, the bonus game including a plurality of bonus game reels;
controlling the plurality of bonus game reels of the bonus game to randomly display one bonus game symbol of a plurality of bonus game symbols in each row for each of the plurality of bonus game reels during a first bonus spin of a predetermined number of bonus spins, the bonus game symbols including a cumulative cash-on-reel (COR) symbol depicting a cumulative COR credit value corresponding to a cumulative credit value defined during the base reel game, prior to the triggering of the bonus event;
in response to at least one row of at least one of the bonus game reels displaying the cumulative COR symbol of the bonus game symbols, continuing to cause to be displayed the cumulative COR symbol in the at least one row of the at least one of the bonus game reels during a subsequent bonus spin of the predetermined number of bonus spins; and
causing to redisplay the bonus game on the display device at a second instance of the bonus event, subsequent to the first instance, the redisplayed bonus game persisting to display the cumulative COR symbol as displayed during the first instance of the bonus event.

9. The method of claim 8, wherein the controlling of the display device to display the bonus event further includes:
determining a first bonus game outcome for the bonus game displayed during the first instance of the bonus event, the first bonus game outcome including a first total credit value for each bonus game symbol displayed during the first instance of the bonus event; and
determining a second bonus game outcome for the bonus game redisplayed during the second instance of the bonus event, the second bonus game outcome including a second total credit value for each bonus game symbol displayed during the second instance of the bonus event,
wherein the second total credit value is equal to or greater than the first total credit value.

10. The method of claim 9, wherein the controlling of the display device to display the bonus event further includes:
determining if each of the rows of the plurality of bonus game reels display the cumulative COR symbol or a bonus cash-on-reel (COR) symbol for the bonus game during the first instance of the bonus event or the second instance of the bonus event, the bonus COR symbol depicting a bonus COR credit value;
in response to each of the rows of the plurality of bonus game reels displaying the cumulative COR symbol or the bonus COR symbol for the bonus game during the first instance of the bonus event:
causing to award the first total credit value; and
causing to award a bonus event credit value; and
in response to each of the rows of the plurality of bonus game reels displaying the cumulative COR symbol or the bonus COR symbol for the bonus game during the second instance of the bonus event:
causing to be awarded the second total credit value; and
causing to be awarded the bonus event credit value.

11. The method of claim 10, wherein in response to each of the rows of the plurality of bonus game reels displaying the cumulative COR symbol or the bonus COR symbol for the bonus game during the first instance of the bonus event, the controlling of the display device to display the bonus event further includes:
causing to reset the bonus event credit value to a minimum bonus event credit value, the minimum bonus event credit value less than the bonus event credit value;
causing to be awarded the second total credit value subsequent to the redisplaying of the bonus game during the second instance of the bonus event, the second total credit value equal to the first credit value; and
causing to be awarded the minimum bonus event credit value subsequent to the redisplaying of the bonus game during the second instance of the bonus event.

12. The method of claim 8, wherein the controlling of the display device to display the bonus event further includes:
causing to be displayed on the display device at least one first bonus feature including a credit value equal to the cumulative credit value defined during the base reel game, prior to the triggering of the bonus event;
causing to be displayed on the display device at least one second bonus feature including a random credit value; and
causing to award at least one of:
the cumulative credit value of each of the displayed first bonus feature, or
the random credit value of each of the displayed second bonus feature.

13. The method of claim 8, wherein the controlling of the display device to display the bonus event further includes:
causing to redisplay the bonus game on the display device at a third instance of the bonus event, subsequent to the second instance, the redisplayed bonus game persisting to display the cumulative COR symbol as displayed during the first instance of the bonus event and the second instance of the bonus event.

14. The method of claim 8, wherein the controlling of the display device to display the bonus event further includes:
in response to at least one row of at least one of the bonus game reels displaying the cumulative COR symbol, continuing to cause to be displayed the cumulative COR symbol in the at least one row of the at least one of the bonus game reels during a subsequent bonus spin of the predetermined number of bonus spins during the first instance of the bonus game.

15. A non-transitory computer-readable storage medium with instructions stored thereon that, in response to execution by at least one processor, cause the at least one processor to:
cause to be displayed on a display device a base reel game including a plurality of reels;
determine that an outcome of the base reel game triggers a bonus event; and
control the display device to display the bonus event including:
cause to be displayed on the display device a bonus game in a first instance of the bonus event, the bonus game including a plurality of bonus game reels;
control the plurality of bonus game reels of the bonus game to randomly display one bonus game symbol of a plurality of bonus game symbols in each row for each of the plurality of bonus game reels during a first bonus spin of a predetermined number of bonus spins, the bonus game symbols including a cumulative cash-on-reel (COR) symbol depicting a cumulative COR credit value corresponding to a cumulative credit value defined during the base reel game, prior to the triggering of the bonus event;
in response to at least one row of at least one of the bonus game reels displaying the cumulative COR symbol of the bonus game symbols, continue to cause to be displayed the cumulative COR symbol in the at least one row of the at least one of the bonus game reels during a subsequent bonus spin of the predetermined number of bonus spins; and
cause to redisplay the bonus game on the display device at a second instance of the bonus event, subsequent to the first instance, the redisplayed bonus game persisting to display the cumulative COR symbol as displayed during the first instance of the bonus event.

16. The non-transitory computer-readable storage medium of claim 15, wherein the instructions, when executed, cause the at least one processor to:
determine a first bonus game outcome for the bonus game displayed during the first instance of the bonus event, the first bonus game outcome including a first total credit value for each bonus game symbol displayed during the first instance of the bonus event; and
determine a second bonus game outcome for the bonus game redisplayed during the second instance of the bonus event, the second bonus game outcome including a second total credit value for each bonus game symbol displayed during the second instance of the bonus event,
wherein the second total credit value is equal to or greater than the first total credit value.

17. The non-transitory computer-readable storage medium of claim 16, wherein the instructions, when executed, cause the at least one processor to:
determine if each of the rows of the plurality of bonus game reels display the cumulative COR symbol or a bonus cash-on-reel (COR) symbol for the bonus game during the first instance of the bonus event or the second instance of the bonus event, the bonus COR symbol depicting a bonus COR credit value;
in response to each of the rows of the plurality of bonus game reels displaying the cumulative COR symbol or the bonus COR symbol for the bonus game during the first instance of the bonus event:
cause to award the first total credit value; and
cause to award a bonus event credit value; and
in response to each of the rows of the plurality of bonus game reels displaying the cumulative COR symbol or the bonus COR symbol for the bonus game during the second instance of the bonus event:
cause to be awarded the second total credit value; and
cause to be awarded the bonus event credit value.

18. The non-transitory computer-readable storage medium of claim 17, wherein in response to each of the rows of the plurality of bonus game reels displaying the cumulative COR symbol or the bonus COR symbol for the bonus game during the first instance of the bonus event, the instructions, when executed, cause the at least one processor to:
cause to reset the bonus event credit value to a minimum bonus event credit value, the minimum bonus event credit value less than the bonus event credit value;
cause to be awarded the second total credit value subsequent to the redisplaying of the bonus game during the second instance of the bonus event, the second total credit value equal to the first credit value; and
cause to be awarded the minimum bonus event credit value subsequent to the redisplaying of the bonus game during the second instance of the bonus event.

19. The non-transitory computer-readable storage medium of claim 15, wherein the instructions, when executed, cause the at least one processor to:
cause to be displayed on the display device at least one first bonus feature including a credit value equal to the cumulative credit value defined during the base reel game, prior to the triggering of the bonus event;
cause to be displayed on the display device at least one second bonus feature including a random credit value; and
cause to award at least one of:
the cumulative credit value of each of the displayed first bonus feature, or
the random credit value of each of the displayed second bonus feature.

20. The non-transitory computer-readable storage medium of claim 15, wherein the instructions, when executed, cause the at least one processor to:
cause to redisplay the bonus game on the display device at a third instance of the bonus event, subsequent to the second instance, the redisplayed bonus game persisting to display the cumulative COR symbol as displayed during the first instance of the bonus event and the second instance of the bonus event.
